(19) United States
(12) Patent Application Publication
(10) Pub. No.: US 2009/0008608 A1
(43) Pub. Date: Jan. 8, 2009

(54) Sodium/silicon "treated" water

(76) Inventors: Mark O. Bublitz, Slocan (CA); George R. King, The Woodlands, TX (US); Julian A. Alexander, Daisetta, TX (US)

Correspondence Address: SHAPER ILER LLP, 1800 WEST LOOP SOUTH, SUITE 1450, HOUSTON, TX, 77027, US

(21) Appl. No.: 11/977,193

(22) Filed: Oct. 24, 2007

Related U.S. Application Data
(60) Provisional application No. 60/854,332, filed on Oct. 25, 2006.

(51) Int. Cl. B01F 1/00; C01B 33/02; C23F 11/00

(52) U.S. Cl. 252/364; 423/347; 252/387

(57) ABSTRACT

A sodium, silicon and water composition characterized predominantly a by sodium to silicon ratio of less than 1.0 and an absence of significant metal hydride, the composition useful in a diluted product with approximately 100 parts de-ionized water, the product further useful in approximately 50/50 ratio with an amine in a gas treatment facility and as an additive to fuel, the invention including the process of making the concentrate and the concentrate defined by process as well as a process of making the diluted product and an amine combination.

This application claims priority to co-pending provisional application No. 60/854,332 filed Oct. 25, 2006, inventor Mark O. Bublitz. The contents of the above referenced provisional application are herein incorporated by reference in their entirety.

### FIELD OF THE INVENTION

The field of the invention lies in sodium, silicon and water concentrates, diluted products thereof, a solvent mixture therefrom, processes for making the above, and at least one preferred use of the solvent in an amine gas treatment plant as well as a use of the diluted product as an additive for fuel.

### BACKGROUND OF THE INVENTION

U.S. Pat. No. 4,029,747 directed to certain Complexes and Products, inventor Merkl, and U.S. Pat. No. 4,571,328 directed to Aqueous Hydrides, inventor Rice, may provide precursors to the instant invention. In a sense the instant invention may also be regarded as an improvement to the invention disclosed in U.S. Pat. No. 6,808,621 (issued Oct. 26, 2004 to Cisneros) as well as to an earlier patent of Cisneros of 1994 incorporated therein by reference, U.S. Pat. No. 5,308,533. The Cisneros '621 and '553 disclose metal hydride compounds having a variety of uses including treating sour gas, making fuel additives, etc. (Please see abstract and text of the '621 and '553.)

The instant inventor believes that Mr. Cisneros, the inventor of U.S. Pat. No. 5,308,553, issued May 2, 1994 and of U.S. Pat. No. 6,808,621, issued Oct. 26, 2004, was in turn influenced by the prior patent to Austin/Battelle, U.S. Pat. No. 3,990,953, issued Nov. 9, 1976 as well as by two prior patents to Rice, U.S. Pat. Nos. 4,570,713 and 4,571,328, both issued Feb. 18, 1986, and possibly by the U.S. Pat. No. 4,029,747 patent issued to Merkl.

It became apparent to the instant inventor that the “metal hydrides” of the Cisneros '621 and '553, proposed to be useful in treating sour gas as discussed in column 17 to column 24 of the '621, exhibited limitations. The problems involved in the Cisneros system for treatment of sour gas and acid gas streams included corrosion and foaming as well as treatment fluid depletion. Further, a related disclosure of “metal hydride” for use in the treating of sour gas, a PCT application PCT/US2005/002038 to David Dutchover, also believed influenced by Cisneros, recited a sodium silicate for use in treating in sour gas. In the instant inventor's opinion, the system disclosed by Dutchover in the PCT application publication No. WO2005/069965, incurred analogous problems to those of Cisnero's system and offered no substantial improvement. The instant invention is an improvement over the sodium silicates and metal hydrides disclosed above.

The instant inventor speculated that one direction to pursue in correcting or eliminating the limitations experienced with the Cisneros and the like “metal hydrides” and sodium silicates lay in the field of “treated water.” (The instant application refers to “doped” water and/or “magnetic” water.) Some familiarity with so-called “parawater” (sometimes called polywater or neowater) influenced the approach. In arriving at the improved concentrate and product and uses disclosed herein, the instant inventor reviewed that art as well as related art. An IDS will provide background. Some principles and/or theories considered pertinent are discussed below as theory and/or possible explanation.

The instant inventor theorizes that the instant “magnetic’ water invention operates in the following manner.

Water structure is normally an unstable structure with continually rotating hydrogen bonds and changing cluster size and direction. When hydrogen bonds are in this state “deprotonation” (“acidic hydrogen”) is available for oxidation reaction. Adding the concentrate and/or diluted product of the instant invention stabilizes the water molecules present, inhibits deprotonation, weakens the dispersion forces and prevents hydrogen bonding, which in turn creates small more stable water clusters. An electromagnetic charge within is believed to be caused by a nano-crystalline silicon crystal positioned and strategically surrounded by linear bonded negatively charged water molecules in a cyclic design. Sodium plays a part in the structure by acting as an insulator to store thermal energy which will be transferred to the nano-crystalline silicon by way of thermal radiation. Its position in the molecular structure is believed to have no significant effect on the designed polar stability, being a dative bond to water's lone pair. Sodium also can affect surface tension and boiling point in some situations as normal sodium would, but it is not believed to be a key to the inventive design's structural bonding.

The instant invention includes a concentrate and a diluted product as well as an amine mixture solvent for gas treatment plants, and processes for making and using the above. From the inventor's viewpoint, the concentrate and the product provide “conditioned” or “treated” water, referred to herein as “doped water,” or best, “magnetic water.”

While the instant inventor does not believe that the metal hydride compounds or compositions of Mr. Cisneros have enjoyed substantial success in the variety of uses for which they were proposed, by contrast the instant invention has proven imminently successful in testing in an amine treatment plant, and preliminary tests as a fuel additive and as a corrosion inhibitor have also been quite promising. Other uses, some similar to the uses recited in the Cisneros '553 and '621, appear promising for the instant invention.

The instant invention may have analogies with so-called “polywater” or “neowater” or “parawater.” However, to the best of our investigations, we do not find the instant invention disclosed in the polywater or neowater art or parawater art. The internet site DO-COOP Technologies LTD discloses a neowater and/or water based nano technology. Neowater™ is taught as building upon unique properties of nanoparticles to modify the physical properties of water molecules around them. The actual composition of “neowater,” however, and the process for making neowater are both apparently retained as trade secrets.

The instant invention, referred to as “magnetic” water for lack of a better term, may be attempted to be explained in more detail by theory. Such was touched upon above and will be attempted in more detail below. However, there are no readily available tests, at least at this time, to easily substantiate the theory. More importantly, the prior art does not refer to itself in terms of this theory. Hence, the instant invention is claimed by methods of manufacture and, importantly, by certain characteristics distinguishing it from the closest known art, testable characteristics.

The instant invention is a composition comprising sodium, silicon, and water. Preferred embodiments of the invention have been created by a combination of sodium hydroxide particles and silicon lumps and de-ionized water. Presuming suitable processing, as taught herein, the resulting composition is importantly characterized and distinguished by a sodium to silicon ratio of less than 1.5 and by an absence of any significant metal hydride by FTIR testing.

Preferred embodiments have a pH of at least 14 and a clear yellow color. Preferred embodiments of the concentrate have a specific gravity of between 1.23 and 1.25 at an approximately 28% solids content. Preferred embodiments of the concentrate have a solids to liquid ratio, by weight, of between to 1 to 2 and 1 to 20. By FTIR testing the concentrate is not, significantly, a metal hydride or a silicon hydride. The absence of metal hydride or significant metal hydride is further illustrated by the fact that the concentrate does not gel upon the addition of hydrogen peroxide. In preferred embodiments of the invention the concentrate is formed from lumps of silicon having trace impurities of phosphorous, iron and calcium. The most useful product based upon the concentrate is a diluted concentrate wherein the concentrate is diluted by addition of roughly 100 parts de-ionized water to one part concentrate. A preferred solvent for use in gas treatment processes of the instant invention comprises an approximately 50/50 mixture of the above diluted product with MEA, DEA and/or MDEA. Although, preferred embodiments of the instant concentrate do not test as a colloidal suspension when filtered at 0.7 μm, the instant inventor believes that the instant invention would show itself to be a colloidal suspension of nanoparticles upon the use of a suitably small filter.

Preferred embodiments of the instant invention are preferably created by placing silicon lumps within a reactor vessel and mixing in a solid (NAOH) sodium hydroxide product until the surface area of the silicon is fully covered. Distilled water at room temperature is carefully added to the reactor over the sodium hydroxide/silicon mixture at approximately a 2:1 water to NAOH volume. The temperature of the mixture will rise. External cooling can be applied to hold the vesel temperature between 165° F. and 195° F. As the liquid decreases small amounts of room temperature distilled water should be added. Sodium oxide and water condensate should be allowed to leave the reaction medium while the vesel temperature is held between 165° F. and 190° F. Normal reaction time should be approximately 6 to 8 hours. At the end of the reaction the liquid should be separated from excess silicon, sealed from atmospheric air and allowed to stabilize for approximately 7 days. This product is a concentrate and should be added to de-ionized water at about a 1 part to 99 part ratio to create a useful product.

### Background Re Gas Treatment Systems

### A Preferred Use

Gas treating in the gas industry has been experiencing the same problems since its inception. In an amine plant the problems incurred consistently are: corrosion, solvent degradation, foaming, and chemical losses.

Solutions to the problem should take into account the operating and chemical reactions happening in the plant operations, such as absorption/desorption rates and, lean amine circulation, inlet gas and lean amine temperature, hydrocarbon saturation, heat stable salt creation, concentrations of amine, activators, corrosion inhibitors, anti-foamers, filtering contaminates and plant design.

Solutions to these four problems have been focused on solvent selection. However, costs of operation and gas sales are also involved in the amine selection through considerations of solvent loss, degradation of solvent, loss of hydrocarbon, addition of control additives, filtration, emissions (reflux and acid gas), failure to meet spec, corrosion of equipment and energy costs.

Further, commercial absorbents for removal of CO₂ require a high net cyclic capacity and high reaction/absorption rate for CO₂ as well as high chemical stability, low vapor pressure and low corrosiveness. Most formulated commercial solvents are proprietary mixtures of traditional amines, anti-foamers, and/or corrosion inhibitors. Formulated solvents are promoted as high performance solutions and command a high price.

One primary difference in the process when using generic amines is in solution concentrations. MEA is ordinarily used in 10-20% by weight in aqueous solution. DEA is used in the 10-30% by weight in the aqueous solution. DIPA, DGA and MDEA are used in higher concentrations. Typically concentration ranges for DIPA and MDEA are 30-50% by weight in the aqueous solution. DGA concentration ranges from approximately 40-70% by weight.

MDEA solvent and proprietary mixtures of amines can be used for bulk CO₂ removal. However, performance can be sensitive to one or more of the operating parameters, such as liquid residence time on the trays, circulation rate and lean amine temperature.

The disadvantages of MEA include high enthalpy of reaction with CO₂, leading to higher desorber energy consumption, the formation of a stable carbamate, (Refer to FIG. 3) formation of degradation products with CO₂ or oxygen-bearing gases, inability to remove mercaptons, vaporization losses due to high VP and being more corrosive. It can only be used in low concentrations.

In the loading range of lower than 0.18 the absorption rate of CO₂ into aqueous 5.0M MEA is generally higher than into all the other absorbents except for aqueous 2.5 MPZ and 4.)

MMEA. Above 0.32 in loading MEA absorption rate become lower than others.

MMEA has a moderate molecular wt. (75 vs 61,) has a moderate carbamate stability resulting in increased absorbed amounts of CO₂ at low partial pressure, has foaming problems (a foam inhibitor will have a negative impact on mass transfer characteristics, reducing interfacial area, and increasing the surface resistance,) and will work better in contactors with two phase design.

The instant inventor has determined that the water is a further important component in the chemical atmosphere, frequently neglected or over looked, and can be the cause of unwanted directions in any chemical reaction in particular, including a gas treatment system. The instant inventor surmised that the treatment water had to be looked at more carefully in order to create the desired chemical directions. It had been known that, from the onset of the creation of the ethanolamine, it “can and will” remove CO₂+H₂S from a gas stream. The amine is not the problem. Further, the amine solution in water is very effective in absorbing the holding H₂S from weak acids when dissolved in water. The instant inventor has determined that a key cause of the above referenced problem is “hydrogen transfer” and “electron depletion,” sparks which set off a domino effect leading to the problems unsolved to date in amine treatment systems. One solution, thus would be to solve the problem by affecting the water structure, stabilizing the amine without affecting its CO₂−H₂S capabilities, possibly enhancing it, and creating a structure acting as a catalyst without interfering with or leaving the system.

Factors to be taken into consideration in gas treating are: (1) MEA—carbamate equilibrium constant is MEACOO+H₂O←→MEA+HCO₃, MEA- degrades to form acidic and basic products; and (2) acidic degradatation forms multi-acids and eventually reacts with bases to form heat stable salts causing corrosion. A reaction with acid to an amine will create heat stable amine salts. Water could add to the problem by carrying carbonates into the equation. CO₂ corrosion in amine units is caused by the reduction of undissociated carbonic acid in turbulent areas (erosion/corrosion.) Refer to FIG. 3 E.g.:

H₂HCO₃+electron→HCO₃+H=corrosion cathode

H₂HCO₃→CO₂+H₂O═CO₂ gas evolution

Fe+H₂S→FeS═H₂═H₂S corrosion

Corrosion is mainly caused by the creation of acids formed in the chemical transfer of CO₂, H₂O and the amine solvent. High flow rates and turbulence can accelerate attack on a metal surface aggravated by the presence of solid particles or entrained gas bubbles.

MEA/DEA/MDEA are the three most popular amines in acid gas treating. MEA has the worst reputation for corrosion but experience has shown no difference in MEA/DEA/MDEA when acid gas is absent. Higher concentrations in all amines have the potential for excess acid gas flashing. “Free” acid gases are a primary contributor to corrosion. Tertiary amines operate better at higher concentrations that that of a primary or secondary structure, a reason for the difference in corrosion between MEA/DEA and MDEA structures. For MEA/DEA, reaction→CO₂→intermediate amines→amine carbamate→internal dehydration (hydrogen transfer)→degradation (electron depletion.) Tertiary MDEA does not follow this direction; a carbamate ion creation is not possible in this structure of amine. Primary and secondary amines have a structure of a hydrogen available for CO₂ absorption: primary has two; secondary has one; and tertiary has none.

Primary and secondary structures have a greater chance of degradation. Hydrocarbon saturation in turn creates carbamates. Polymerization (the ability to form hydrogen bonds to each other at high temperature and/or high concentration) with this known, tertiary amine would be the choice in a normal amine/water mix. A tertiary amine structure cannot absorb CO₂ directly and must rely on the water content for removal. It degrades in the direction to a secondary structure. (Refer FIG. 5 and FIG. 4)

With the above known and taken into account, a primary and/or a secondary amine structure would be the choice, if it could be stabilized to a point that the hydrogen atoms were designed to never release from the nitrogen bond. This could be accomplished, it is believed, by stabilizing the “odd electron” in a water structure, in turn affecting the unshared electron pair of the Nitrogen center (knowing an “amide” is stabilized by resonance involving the nonbonding pair of electrons on the nitrogen atom.) All amines are moderately polar substances and can be affected with outside inter molecular induced forces to stabilize. Thus it is believed, affect water=stabilized amine structure. (Refer to FIG. 1, FIG. 2)

The absorption or desorption of H₂S and CO₂ in amine solutions involves a heat effect due to the chemical reaction. This heat effect is a function of amine type concentration and the mole loading of acid gases. The heat of solution of acid gases is usually obtained by differentiating the experimental solubility data using a form of the Gibbs-Helmholtz Equation. The heat affects the results from evaporation and condensation of amine and water in both the absorber and regenerator of liquid enthalpy. The water content of the sour water gas feed can have a dramatic effect on the predicted temperature profile in the absorber and should be considered, especially at low pressures.

Different amine structures and their ability to affect water solubility, CO₂—H₂S absorption/desorption suggested to the inventor considering:

stronger Lewis base more chance of creating carbamates

hydrocarbon attachment due to missing nucleophile

hydrogen bonds created

releasing of electrons

how amides stabilize

importance of nonbonding pair of electron of the nitrogen atom

primary-secondary can form hydrogen bonds to each other

tertiary amine cans only hydrogen bond to water or other hydroxylic solvents

odd electron to be stabilized

problems and differences of primary-secondary and tertiary amines used in the past

why lower concentration degradates slower

To summarize, what has been discovered and/or theorized is that all malfunctions and chemical breakdowns occur due to hydrogen transfer and electron depletion within the chemical atmosphere. It starts with amine→carbamate→hydrocarbon saturation→foaming→salt→creation→degradation of amine. The stronger Lewis Base leads to chance of creating carbamate→more carbamates create salts→hydrogen depletion leave room for hydrocarbon attachment→causes foaming due to missing nucleophile→loss of solvent. To create an optimally designed final product, all steps should be considered with respect to the chemical reaction directions.

### DISCUSSION OF THE INVENTION

The inventor at least theorizes that he has achieved a suspension of nanocrystalline silicon particles, coated by water carrying an electromagnetic charge, and wherein the water is substantially monopolar and the sodium is significantly dormant (“magnetic water.”) The instant inventor further theorizes that the high pH is due to the doping of the water rather than the sodium.

A concentrate and a diluted product thereof, according to the instant invention has certain desirable characteristics. Illustrative beneficial features of the instant “magnetic water,” as for instance when mixed with MEA, DEA or MDEA as a solvent in an amine treatment plant, are a resultant lack of solvent degradation, lack of foaming and lack of corrosion. Preferably the product contains less than 0.25 parts per million silicon and sodium.

Some Objectives of the Invention
(1) prevention of corrosion of metal surfaces within an amine circulation system of an acid gas treatment plant by creating a chemical atmosphere to avoid electron, depletion of metal surfaces, and releasing surface tension;
(2) prevention of degradation of amine structures within an amine circulation system of an acid gas treatment plant by (in theory) avoiding hydrogen deprotonation, avoiding creation of carbamates, carbonates which in turn create salt structures;
(3) prevention of hydrocarbon saturation of amine structures within an amine system of an acid gas treatment plant by (at least in theory) preventing deprotonation of amine;
(4) prevention of foaming within an amine system of an (in theory) an acid gas treatment by preventing hydrocarbon saturation;
(5) creating a multiple amine structure by (in theory) utilizing a primary or secondary amine structure with to the high base water created by this invention. (Refer to FIG. 6)

Further Uses of Invention:
(6) the product can be used in a low pressure bubble tower or wet scrubber to remove sulfur, nitrogens and VOC's from the gas stream;
(7) the product can be injected into a high pressure gas pipe line to remove surface tension and prevent corrosion of the metal surfaces without interfering with the gas structure;
(8) the product can be utilized as a scavenger liquid to inject into a gas pipe line stream to lower sulfur and CO₂ contaminants:
(9) the product can be utilized within a fuel refiner to remove sulfur and water contaminates from hydrocarbon structures;
(10) this product can be utilized to increase solubility qualities and lower corrosion effects of alcohols to hydrocarbons.

### Further Background Theory Summary

In creating the invention the inventor has attempted to theoretically take into consideration the elements involved in, and what the root causes are of, the problems within an acid gas-amine system. A key root cause appears to be, in theory, “electron depleted hydrogen released from hydrogen bonded molecules causing an acidic atmosphere, electron depleted compounds and forming unwanted compounds within the chemical atmosphere. When hydrogen is released from the amine or water molecule it will create a carbamate or carbonate with CO₂ Hydrogen depleted amine now could polymerize or attach to a hydrocarbon. A free hydroxide ion can bond to a salt or oxidize the metal surface. All problems may start with the release of acid hydrogen involved in a hydrogen bond compound and snowball into the other problems dealt with in amine sweetening systems.

A Theoretical Summary as to Why this Product Works in an Amine Plant:
1. prior formulas considered in CO₂+H₂O removal using amines to treat natural gas do not consider water in the mass transfer equations, which increase acid hydrogen involved;
2. the electro negativity of oxygen and nitrogen are far stronger than hydrogen which can be the main reason for “deprotonation;”
3. an electromagnetic force introduced in a water medium may distort “Van der Waals” forces that forms normal water molecule structures, affecting bond angles and preventing hydrogen bonding, deprotonation and electron depletion.

From one perspective the invention might be theoretically characterized as an electromagnetic water crystal carrying a charge within the UV visible spectrum which interferes with the dispersion forces of molecular lone pairs within the liquid medium. This electromagnetic radiated water is designed to be added, in one preferred embodiment, as the water percent of an amine mixture in amine circulation system of an acid gas treatment plant. It creates a “multiple” amine structure with exceptional loading capabilities, prevents corrosion of metal surfaces, avoid polymerization of amine and in turn degradation, salt creation, hydrocarbon saturation, foaming, and product loss due to these problems. This is accomplished in theory by the specific internal electromagnetic force interfering with the electron affinity of oxygen's lone pair repulsive force to prevent hydrogen bonding, deprotonation of hydrogen, and crate an excess electron atmosphere to avoid acid creation and oxidation of metal surfaces by magnetically relieving surface tension.

From a second perspective the invention might be characterized as a colloidal liquid containing water coated nano-crystalline silicon carrying an electromagnetic charge in the UV visible spectrum within a water medium. This liquid is designed with an internal electromagnetic force which will distort or arrange the intermolecular force of non-bonding lone pair electrons of oxygen and nitrogen compounds involved in water, alcohol and amine structures, in turn affecting hydrogen bonds, bond angles, bond strengths, preventing deprotonation and/or electron depletion.

From a third perspective the invention may be characterized as stabilizing an ethanolamine by adding water and a soluble colloidal dispersion to crate an electromagnetic solution which prevents hydrogen transfer and electron depletion when applied in a gas stream to remove CO₂ and H₂S from hydrocarbon structures. As such this perspective of the invention takes into account forces between molecules such as dipole to dipole, London forces and hydrogen bonding. E.g. Water=London forces and hydrogen bonding→surface tension.

The invention comprises a concentrate composition including sodium, silicon and water. The composition is predominantly characterized by a sodium to silicon ratio of less than 1.5 by weight and by an absence of significant metal hydride. Preferably the composition is formed by combining at least sodium hydroxide, silicon lumps and de-ionized water. Preferably also the composition has a pH of approximately 14 and a specific gravity of approximately 1.23 to 1.25 at a concentration of 28% solids. Preferably the concentrate composition has a solids to liquid ratio by weight of between 1 to 2 to 1 to 20. Preferably further the composition has a clear yellow color and is formed from silicon having a trace amount of phosphorous, iron and calcium.

The invention includes a product form of a diluted concentrate wherein the composition above is combined with de-ionized water at a ratio by weight of approximately ½ to 2 parts composition to 100 parts water to form a diluted product.

The invention also includes a solvent comprised of the above diluted product combined with at least one of MEA, DEA and MDEA in approximately a 50/50 ratio.

The invention further comprises the product made by the process disclosed herein and methods of use of the product.

### Invention Structure Theory

It is believed that the instant invention involves a nanocrystalline silicon particle surrounded within a water medium involving distorted water molecules that have only a negative charge. This crystal structure has the capability to absorb energy to influence the internal dispersion forces of molecules of a solution such as water itself.

Due to the electromagnetic force displaced through the water medium the Van der Waal effects in the solution redesign the molecular characteristics such as boiling point, vapor pressure, surface tension, solubility, bond angles, and energy content. This takes place due to the influence on hydrogen bonding in polar solutions and temporary dipole interactions within non-polar solutions by the electromagnetic charge of the silicon crystal.

This nanoparticle when added to a deionized water medium will electromagnetically affect the electro negativity of the water structure by induced negative force, supplied by the nanoparticle charge, placing an opposite directional force to the non-bonding lone pairs decreasing electron affinity of the oxygen, releasing hydrogen bonds and equalizing the hydrogen-oxygen covalent bond. The bond angle becomes more linear forming a monomer water chain with delocalized O—O—O ppi-bond overlap. In this structure oxygen will act as a paramagnetic oxygen molecule while hydrogen can evolve and survive as a hydrated electron within the water medium.

In conclusion, it is suggested from quantum chemistry and available experimental information that pentagonal dodecahedral water clusters may play active roles in a wide range of chemical, catalytic, biological, and astrophysical scenarios. Furthermore, the technological use of such water clusters to enhance combustion and significantly reduce pollutants in fossil fuels has recently been demonstrated.

Further, if interacting water-cluster O—O—O ppi-electrons and low-frequency vibrations are relevant to the properties of liquid water at ordinary atmospheric pressure and temperature, it is likely that they also play key roles at the high pressures and temperatures of supercritical water. In fact, it has been deduced from x-ray and neutron diffraction studies of supercritical water that its extraordinary physical and chemical properties are associated with increased 0-0 bonding at the expense of significantly decreased hydrogen bonding due to water molecule clustering.

### Product

The main chemical feature of this inventive product is to interfere with the Van de Waal forces of non bonding lone pair molecules affecting Hydrogen bonds and temporary dipole interactions in non-polar molecules.

Hydrogen bond interference avoids deprotonation and stabilizes and prevents Hydrogen-Hydrogen bonding. This effect prevents acidic solution creation; smaller, more stable molecular structure in-turn changes characteristics of the solution. Boiling point, bond angles, vapor pressure, releases surface tension, viscosity and becomes unable to oxidize due to electron efficiency.

Temporary dipole interactions; the product stabilizes electron movement to induce attractive forces between non-polar molecules. This electrostatic interference creates a more stable solution with charged characteristics such as solubility, energy content, surface tension, viscosity, vapor pressure and boiling point.

### One Key to Product Invention

By placing a suspended colloidal charged particle within a water medium it will distort and/or weaken the London dispersion force of the non-bonding lone pairs of Nitrogen-Oxygen-Halogens-Sulfur which in turn weaken the Hydrogen bonding strength. This avoids Hydrogen leaving without its electron when separation happens.

Hydrogen bonds have about a tenth of the strength of an average covalent bond, and are being constantly broken and reformed in liquid water. If you liken the covalent bond between the oxygen and hydrogen to a stable marriage, the hydrogen bond has “just good friends” status. On the same scale, Van de Waal attractions represent mere passing acquaintances.

### Perceived Advantages

1) This inventive product will prevent deprotonation of an ethanolamine by interfering with the lone pair dispersion force during CO₂ removal from a hydrocarbon acid gas stream preventing the formation of carbamates in turn hydrocarbon saturation which is the cause of acidic qualities and foaming within the treatment system.
2) This inventive product will prevent deprotonation of an ethanolamine by interfering with the lone pair dispersion force during CO₂ removal from a hydrocarbon acid gas eliminating salt creation and degradation of the amine solution,
3) This inventive product will create a multiple amine solution by water becoming basic to absorb CO₂ and ethanolamine in turn will absorb CO₂ to their Hydrogen.
4) This inventive product will prevent deprotonation and/or electron depletion in Alcohol, Amine, Water and Fatty Acid Esters by dispersion force interference to eliminate corrosion of metal surfaces.
5) This inventive product will relieve surface tension; in turn increase lubricity of liquids involving oxygen, nitrogen, sulfur and Halogens by interfering with internal dispersion forces affecting hydrogen bonding. Also non-polar solutions will be changed in the same direction by stabilizing the temporary dipole interactions.
6) This inventive product will lower vapor pressure of non-polar liquids stabilizing temporary dipole interactions by electrostatic interference to induce attractive forces between molecules creating a more stable liquid.
7) This inventive product will prevent corrosion involving liquids with oxygen, nitrogen, sulfur or halogens by interfering with internal dispersion forces involving lone pairs and hydrogen bonding preventing deprotonation and electron depletion of contacting metal surfaces. (will create a non-polar surface tension on the surface tension on the surface of the metal)
8) This inventive product will increase energy content of fuels by interfering with internal dispersion forces and temporary dipole interactions to change bond angles to a higher energy designed structure.
9) This inventive product will change solubility qualities of liquids by interfering with internal dispersion forces and stabilizing temporary dipole interactions.

### There are Two Basicity Constants

1) OH⁻ in the solution
2) electron excess
   ACS LABS Testing: Evaporated all liquids from sample—weighed solid—let set in the atmosphere overnight—weighed solid again. Solid did not pick up any moisture which says, Hydroxide is not high ph “Basicity”. This means electron excess is the reason for the high pH “Basicity” within the product solution.

### SUMMARY OF THE INVENTION

The invention includes a concentrate comprising sodium, silicon and water. The concentrate is characterized by a sodium to silicon ratio of less than 1 by weight, by an absence of significant metal hydride, by color of amber to yellow and by pH of at least 12.65. Preferably the color is a clear yellow and the pH is at least 14. Preferably the concentrate is formed by initially combining sodium hydroxide, silicon and distilled water in weight ratio of approximately 1 unit to 2 units to 8.3 units, respectively.

A useful product is formed from the concentrate by combining one unit of concentrate with 50 to 200 parts by weight deionized water. Preferably one unit of concentrate is combined with approximately 85 to 100 parts by weight deionized water. A combination of 1 to 99 is favored.

A useful solvent utilizing the product comprises the diluted product combined with at least one of MEA, DEA and MDEA in approximately a 50 to 50 ratio.

The invention includes a process for making a sodium/silicon water concentrate comprising the steps of mixing approximately 1 unit by weight of solid NaOH with two units by weight silicon in an open reaction vessel. Quickly and calmly approximately 8.3 units by weight room temperature distilled water is added to the caustic/silicon mixture. Over the next six to eight hours small amounts of room temperature distilled water are added to maintain the internal temperature of the composition below 300° F. Subsequently the liquid is allowed to set for approximately 24 hours. Then a liquid concentrate is separated from excess silicon by pouring concentrate off of a silicon sediment in the vessel. The concentrate is preferably sealed from the atmosphere for at least 100 hours. The invention includes the product made by the above process.

### BRIEF DESCRIPTION OF THE DRAWINGS

A better understanding of the present invention can be obtained when the following detailed description of the preferred embodiments are considered in conjunction with tables and the following drawings.

FIG. 1 MEA is an example of a monoethanolamine with two hydrogen bonds with the nitrogen and one on the alcohol oxygen. These three hydrogen bonds are stabilized internally by weakening the lone pair's dispersion force, thus avoiding deprotonation.

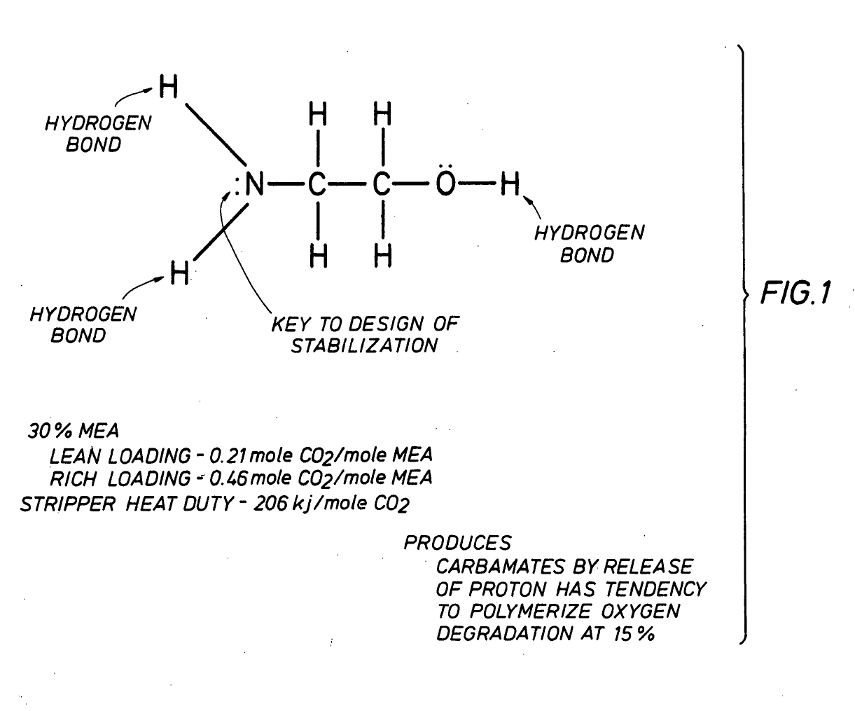

FIG. 2 DEA is a diethanolamine with one hydrogen bond to the nitrogen and one each on the two alcohol oxygens. These three bonds are stabilized internally by weakening the lone pair's dispersion force, thus avoiding deprotonation.

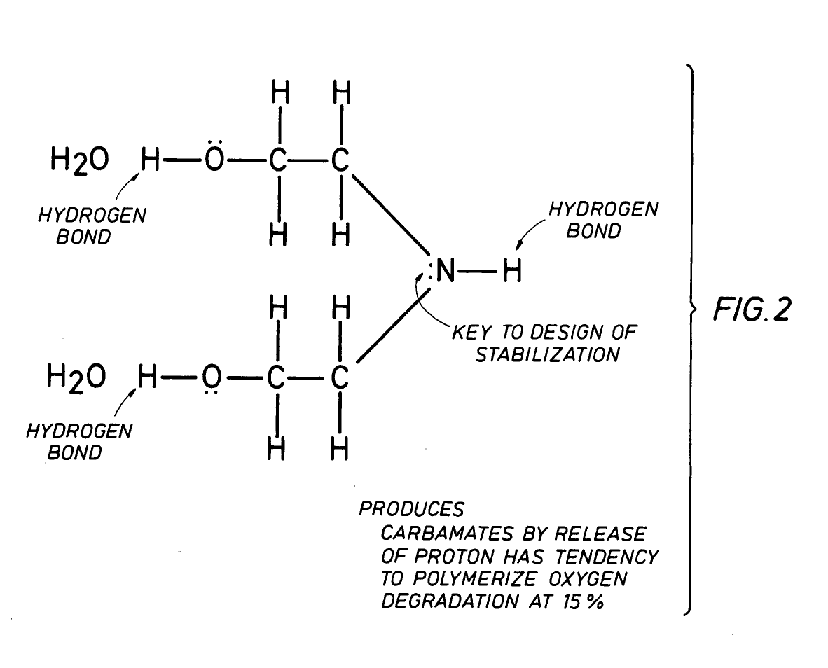

FIG. 3 is an explanation of the structure and formation of the acidic structure of a carbamate formed from CO₂ and a deprotonized amine. This only can occur from an ethanolamine with a nitrogen-hydrogen bond.

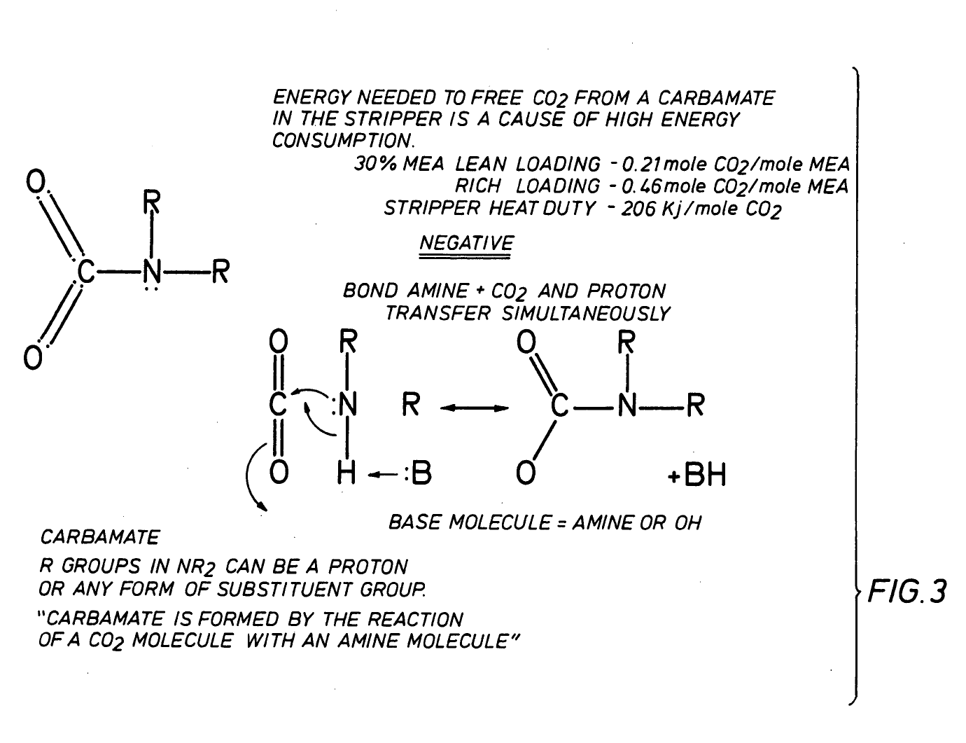

FIG. 4 MDEA is an ethanolamine with no nitrogen-hydrogen bonds. It does have two hydrogen bonds on the alcohols which can deprotonate.

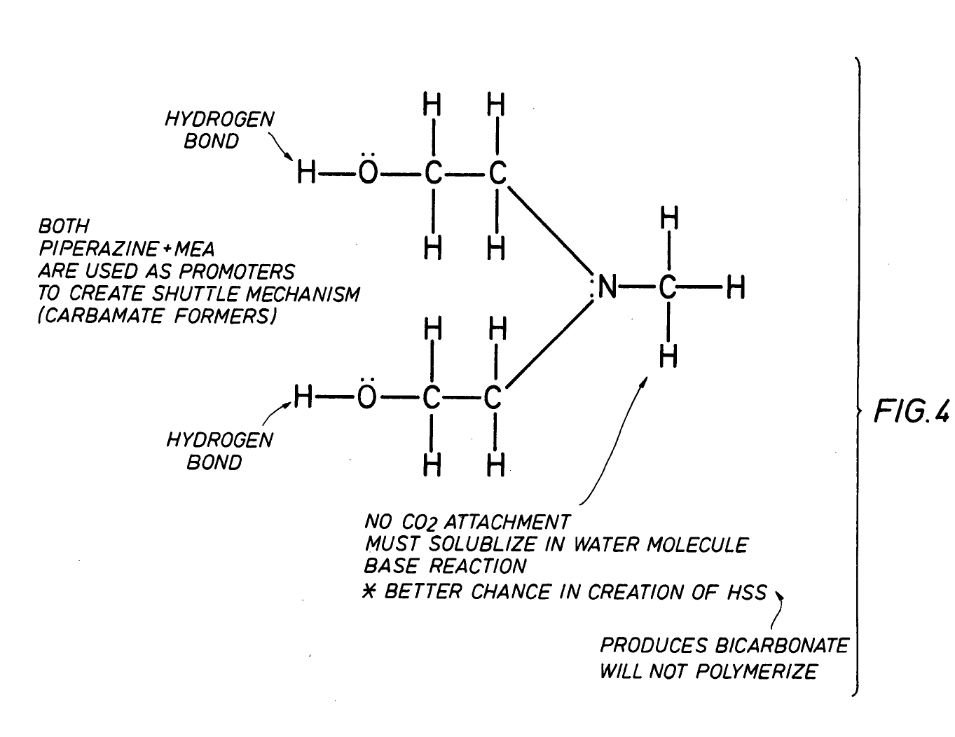

FIG. 5 is a explanation of the structure and formation of a bicarbonate created from a CO₂ molecule and deprotonated water molecule. This is the beginning of degradation of an ethanolamine with no nitrogen-hydrogen bond (MDEA)

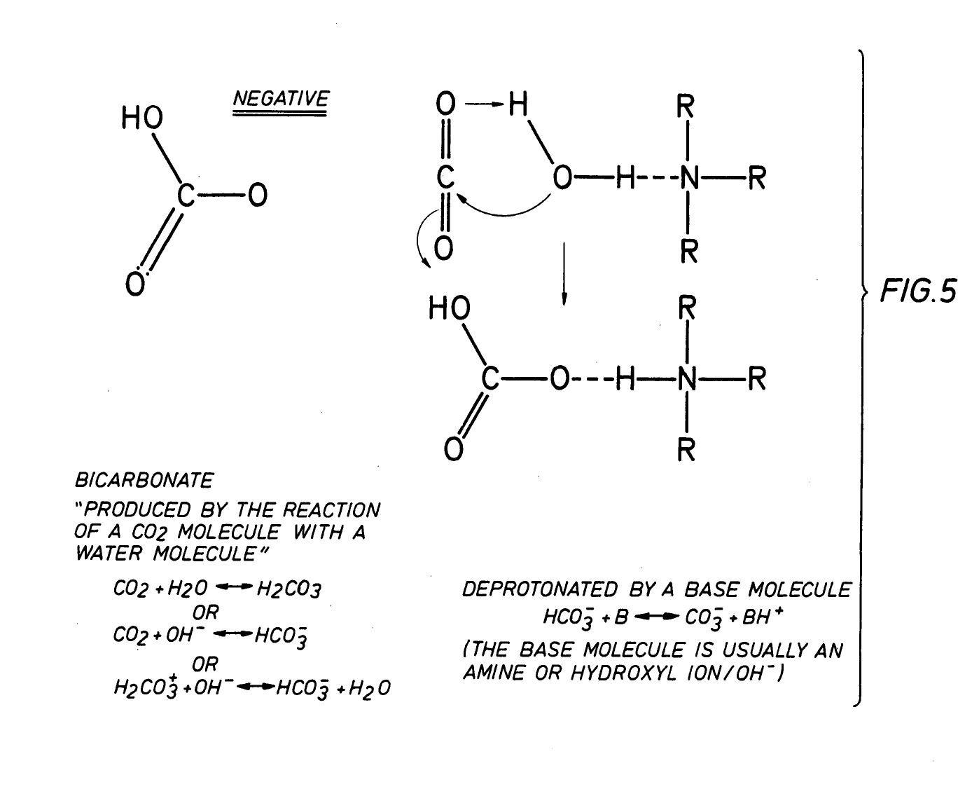

FIG. 6 is an example of how a multiple amine structure works in removing CO₂ from an acid gas.

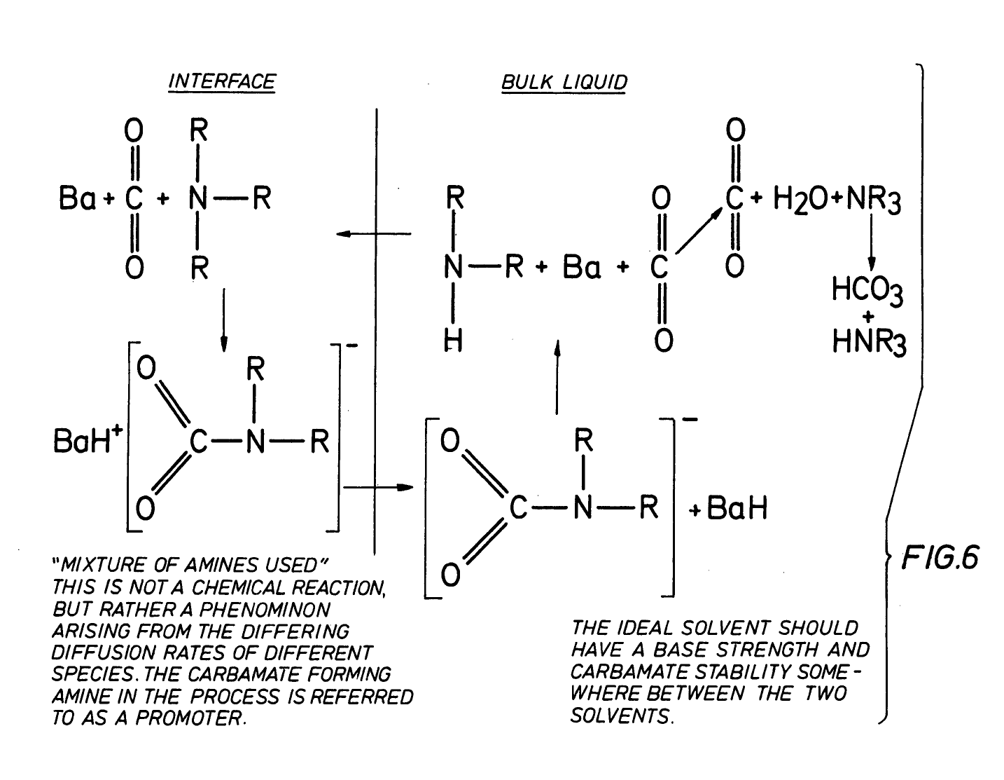

The drawings are primarily illustrative. It would be understood that structure may have been simplified and details omitted in order to convey certain aspects of the invention. Scale may be sacrificed to clarity.

### DETAILED DESCRIPTION OF PREFERRED EMBODIMENTS

### Background Re Contaminants in an Amine Gas Treatment Plant

### Amine Contaminants

Amine contaminants can be grouped into five distinct categories; (1) heat stable salts, (2) degradation products, (3) injection chemicals, (4) hydrocarbons and (5) particulates. All of these contaminant categories can typically be present in any given amine system at the same time, although the amount of each one can vary from insignificant to several percent.

Heat Stable Salts: Strong acid anions such as formate, acetate, thiosulfate, thiocyanate, and chloride can tie up an amine molecule to a form of salt that is not capable of being regenerated by the addition of heat and are thus referred to as Heat Stable Salts. Not only do they tie up the amine and thereby reduce the acid gas carrying capacity, but they are also considered corrosive.

However there is still a considerable amount of confusion in the industry over the term “heat Stable Salt.” Many times the term is used in a generic sense to mean “contaminant,” while in fact it is only one type of amine contaminant, and may not even be the most offensive contaminant. New engineers assigned to amine and sulfur plant areas often assume that the only contaminants in their amine system are the Heat Stable Salts. This idea can be reinforced when tab analyses show only Heat Stable Salt contaminants, but do not report other types of contaminants such as degradation products.

Degradation: Degradation products are contaminants in solution that are derived from the breakdown of the base amine molecule itself, often irreversibly, to form totally different chemical species. Examples of degradation products are the ethylenendiamine derivatives (THEED in the case of DEA), which can form when CO₂ COS or O are in an amine system.

The loss of amine to degradation can be deceiving because these products can still have base strength and will show up as amine under normal titration, but they no longer have any acid gas removal capability. Degradation products continue to be the target of ongoing research as to any negative effects on amine solutions (corrosivity and other physical properties.) Because they have only recently been considered important to measure, degradation products, such as bicine, are difficult for labs to consistently measure in small quantities, and can add to analysis expense.

Injection Chemicals: Corrosion inhibitors from upstream pipeline operations and amine system injections, such as anti-foam chemicals, can concentrate in amine systems. While these chemicals are excellent in controlling operating problems, their injection into an amine system over them months and years between turnarounds can build up to a substantial percentage of the amine concentration. A large buildup of injection chemicals can eventually lead to fouling and can cause changes in solution physical properties, such as viscosity and mass transfer.

Hydrocarbons: Heavy hydrocarbons from natural gas streams can condense in the contactor, and lubrication oil from upstream reciprocating compression can build up in amine systems over time. These hydrocarbons can cause foaming, and at high enough concentrations can change amine solvent physical properties.

Particulates: Typical insoluble particulates include iron sulfides, metals from equipment corrosion, charcoal from amine filters, and catalyst fines from contaminants found in amine systems come from three sources: (1) makeup water, (2) feed gas and (3) derived contaminants formed by reactions of amine contaminants from sources (1) and (2).

Makeup Water Contaminants:

Pure water, either de-ionized or distilled, is recommended as make up for amine systems. (Deionized presumes demineralization herein.) Otherwise a number of contaminants such as sodium, potassium, calcium, magnesium, chloride, sulfate and bicarbonate ions can enter the system with impure water make up water. These strong anions will react to tie up the amine cation to form Heat Stable Salts, as shown:

HOC₂H₄NH₂+CI═HOC₂H₄NH₃⁺CI
DEA Chloride DEA-Chloride
   Heat Stable Salt

Feed Gas Contaminants:

In natural gas service, contaminants entering with the feed gas are generally less troublesome than refinery feed gas contaminants. Contaminants in natural gas feeds that typically cause the most problems in amine systems are oxygen, carbonyl sulfide, and carbon dioxide, and hydrocarbons.

It is not uncommon for all small amounts of oxygen to be drawn into the suction side of low-pressure field compressors in natural gas gathering systems. The oxygen molecule will then react to provide a number of contaminants in amine solutions. For instance, oxygen will react with hydrogen sulfide to eventually form thiosulfate and sulfate salts, which are heat stable. Oxygen will also react with amines to form formic, glycolic and oxalic acids, the ions of which form Heat Stable Salts.

### Derived Contaminants:

Carbon dioxide, which is often a component of sour natural gas feeds, will also react to form contaminants that can react with the amine molecule to form degradation compounds. Amine degradation chemistry is more complex than salt formation, because a series of intermediate compounds are formed that continue to react to eventually form ethylenediamines. Typical degradation compounds are listed below.

Amine Degradation Products

| | | | |
|---|---|---|---|
| Amine | +O₂ | carboxylic acids | heat stable salts |
| | | imidazolidone | |
| MEA | +CO₂ | oxazolidon | OZD |
| | | hydroxyethyl imidazolidone | HEI |
| | +COS | Hydroxyethyl ethylenediamine | HEED |
| | | diethanolurea | |
| DGA | +CO₂ | bis hydroxyethyl ethoxy urea | BHEEU |
| | +COS | bis hydroxyethyl ethoxy thourea | |
| DEA | +CO₂ | hydroxyethyl oxazolidone | HEOD |
| | | bis hydroxyethyl piperzine | BHEP |
| | | tris hydroxyethyl ethylenediamine | THEED |
| | +COS | monoethanolamine | MEA |
| | | hyroxyethyl imidazolidone | HEI |
| | | bis hydroxethyl ethylenediamine | BHEED |
| DIPA | +CO₂ | hydroxymethyl propyl oxazolidone | HMPO |

When it comes to amine contaminants, the areas of confusion that still exist mainly have to do with terminology and measurement.

Even the term “Heat Stable Salt” can have different meanings to different labs. Heat Stable Salts can be reported as HSS Anions (not connected to any specific cation, HSAS (heat stable amine salt, with anion connected to an amine cation), or simply as HSS (measured as a heat stable salt anion connected to a sodium cation.) Some contaminants may be reported in terms specific to that lab only, and are not easily converted into a basis used by another lab or quality guidelines found in technical literature. Examples of these terms are: HSS, HSS Anions, HSAS, ash, bound amine, and fragments.

The units of measurement an also vary in different lab reports. HSS can be reported at least three different ways, and it is important to understand the differences:

HSS Anions—Weight Percent of Solution

HSS anions measured as weight percent of the total solution.

HSS—Expressed as Weight Percent as Amine

This unit of measurement assumes that the HSS anions are bound to an amine cation (also reported as HSAS, Heat Stable Amine Salt). This number is determined by calculating the equivalent amount of amine cations that are tied up with the HSS anion, and is expressed as weight percent of the total solution.

HSS—Expressed as Percent of Amine Capacity

Amine HSS (or HSAS) expressed as weight percent amine, divided by the amine strength.

As an example, the same MDEA sample could be reported three different ways, with a substantial difference in the percentage depending on what measurement units are used.

| | |
|---|---|
| Amine Strength wt % | 30.5 |
| HSS anions wt % | 5.33 |
| HSS expressed as wt % as MDEA | 13.13 |
| HSS as Percent Amine Capacity | 43.05 |
| MDEA MW = 119 | |
| HSS Anion MW = 48.2 | |

As a matter of clarification, there is absolutely nothing wrong with these specific contaminant terms and measurement units. On the contrary, they provide an excellent way of keeping up with the amine contaminant trends when the amine contaminant trends when the same lab analysis is used consistently. However, caution should be used when two separate labs analyze your amine for comparison purposes. Likewise, care should be taken when a lab analysis is compared to quality guidelines. Make sure to use the same basis when comparing two analyses.

Specific (HSS) Anion Guidelines

| Organic | | Inorganic | |
|---|---|---|---|
| HSS Anions | Limit, ppm | HSS Anions | Limit, ppm |
| Acetate | 1000 | Chloride | 500 |
| Formate | 500 | Sulfate | 500 |
| Oxalate | 250 | Sulfate | 500 |
| Glycolate | 500 | Thiosulfate | 10,000* |
| Malonate | 500 | Thiocyanate | 10,000 |
| Succinate | 1000 | | |

MEA

| | |
|---|---|
| Free Amine (Alkalinity) | 20 wt % Max |
| Water | 70 wt % Min. |
| HSS | <2.5 Expressed as wt % as MEA |
| | <8.0 Percent Amine Capacity |
| Formamides (MEAF) | <3.0 wt % |
| HEED | <0.5 wt % |
| HEEU | <1.0 |

DGA ®

| | |
|---|---|
| Free Amine (Alkalinity) | 30 wt % Max |
| Water | 40 wt % Min. |
| HSS | <2.5 Expressed as wt % as DGA ® |
| | <8.0 Percent Amine Capacity |
| Formamides (DGAF) | <3.0 wt % |
| BHEEU | <6.0 wt % |

DEA

| | |
|---|---|
| Free Amine (Alkalinity) | 30 wt % Max |
| Water | 60 wt % Min. |
| HSS | <2.5 Expressed as wt % as DEA |
| | <8.0 Percent Amine Capacity |
| Formamides (DEAF) | <3.0 wt % |
| THEED | <1.5 wt % |

MDEA

| | |
|---|---|
| Free Amine (Alkalinity) | 50 wt % Max |
| Water | 40 wt % Min. |
| HSS | <2.5 Expressed as wt % as MDEA |
| | <8.0 Percent Amine Capacity |
| Formamides (DGAF) | <2.50 wt % |
| BHEEU | <0.4 wt % |

### Amine Contaminator

MEA contamination/Degradation

| | | |
|---|---|---|
| HSS | Potentially Corrosive | Contaminant |
| Formamide (MEAF) | Non-Corrosive | Contaminant/Degradation |
| HEED | Potentially Corrosive | Degradation |
| HEEU | Non-Corrosive | Degradation |
| Polymeric Material | Non-Corrosive | Degradation |

DEA Contamination/Degradation

| | | |
|---|---|---|
| HSS | Potentially Corrosive | Contaminant |
| Formamide (DEAF) | Non-Corrosive | Contaminant/Degradation |
| THEED | Potentially Corrosive | Degradation |
| Bis-HEP | Non-Corrosive | Degradation |
| MEA | ASCC Concerns | Degradation |
| Bicine | Potentially Corrosive | Degradation |
| Polymeric Material | Non-Corrosive | Degradation |
| HEEU | Non-Corrosive | Degradation |
| Polymeric Material | Non-Corrosive | Degradation |

DGA ® Contamination/Degradation

| | | |
|---|---|---|
| HSS | Potentially Corrosive | Contaminant |
| Formamide (DGAF) | Non-Corrosive | Contaminant/Degradation |
| BHEEU | Non-Corrosive | Degradation (Reversible) |
| Polymeric Material | Non-Corrosive | Degradation |

MDEA Contamination/Degradation in TGTU Service

| | | |
|---|---|---|
| HSS | Potentially Corrosive | Contaminant |
| MMEA | Non-Corrosive | Degradation |
| DEA | Non-Corrosive | Degradation |
| Bicine | Corrosive | Degradation |
| HE-Sarcosine | Corrosive | Degradation |
| Polymeric Material | Non-Corrosive | Degradation |

### Molecular Theory and Application to Contaminants

London Forces are present between all molecules and are particularly important for large molecules.

Polarizability of an atom or molecule is a measure of the ease with which the electrons and nuclei can be displaced from their average positions.
crystal structures
melting points
boiling points
heats of fusion and vaporization
densities

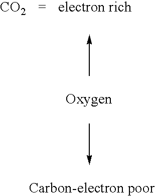

(London Force)→Transitory Forces←Water effect

When water from hydrogen and oxygen gases, the hydrogen atoms move from an oxidation state of zero to one of +1, conversely the oxidation state of the oxygen atoms goes from zero to −2.

If water were an ionic compound, we could imagine the oxygen having a double negative charge, but because the molecule is electrically neutral the hydrogen atoms to be assumed to be lacking an electron and therefore have a single positive charge. Thus, it is known as Diamagnetic.

By introducing excess electrons at a specific time of dissociation of water, the dispersion force of the water molecule is neutralized and the water is redesigned as an ionic negative charge molecule. Molecules are stabilized because they are magnetically attached to a macro liquid crystal with a high positive center charge, forming a negative water nanoparticle in a polymer formed design. Its Zeta Potential is drastically increased, affecting surface tension and electronic charge and pH, due to excess electrons creating hydrated electrons and O₂ as water elements. When added to nonpolar liquids, this design will place a magnetic charge to other London Forces, thus weakening them, creating new elements and/or molecules by “electron addition.”

CO₃²⁻+CO₂+H₂O←→2HCO⁻₃
Carbon monoxide and nitrous oxides are very weak and do not chemically react with alkanolamines.
Sulphur dioxide and nitrous dioxide form very strong chemical bonds with alkanolamines. Heat required to break these bonds will decompose amine structure.

### Carbonyl Sulphide:

Carbon Disulphide: both react with primary amines, forming non-regenerative degradation products. Mercaptons are weak with gases that are not readily removed by ANY alkanolamine

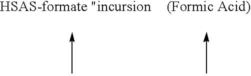

Other acidic compounds These acids combine with Amine to create HSAS from H₂S/CO₂

Some reactions depend on the base strength of the amine; the final reactions depend on the stability of the carbamate molecule formed by a given amine.

The CO₂ absorption process is usually based on temperature variation, and the temperature dependency of the equilibrium constants is clearly required to predict the performance of a given solvent.

The equilibrium constants in the system do also change as a function of the composition of the liquid and the concentration dependency of the equilibrium constants are clearly of importance.

Tertiary amines do not form carbamate and for such molecules the base strength is the only equilibrium constant governing the reactivity towards CO₂

Base strength and carbamate stability together provide what can perhaps be summarized as a direction to a new solvent design.

carbamate stability and rate of reaction

base strength and rate of reaction

The ideal values for these directive reactions are still unknown.

It is known that change in basicity over temperature depends on the nature of the intramolecular hydrogen bonding of a given molecule. Predicting the change in the carbamate stability over temperature is more difficult.

The number of reactions involved in the CO₂ absorption process is quite small. It can not be ruled out that other reactions take place, but the present set of reactions can account for most behaviors of CO₂ absorption in amine systems. All reactions known involving CO₂ can be generalized.

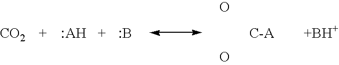

B is a base molecule and AH is any molecule with a free-electron pair and a hydrogen atom on the same site.
Carbamate—If AH is an amine molecule and B is a water molecule a second amine molecule this is the carbamate formation mechanism.
Base Catalyzed—If AH is a water molecule and B is an amine molecule the reaction is base catalyzed bicarbonate formation.
Bicarbonate—If both AH and B are the water molecules the reaction is a standard bicarbonate formation.

### Solubility of Amine in Water

Loss of solvent by evaporation in the stripper and absorber can be a problem with a normal amine. If a solvent has low solubility in water that will also limit the amine concentration under which the process can be operated. The calculation of salvation energy is important for the solvent itself. (which is a neutral molecule.) (moderately polar).

Base molecules must be present for CO₂ to bond to amine molecules. This would suggest that if any reaction intermediate exists, it can not be very stable and is likely to be short lived. If a strong base (such as another amine molecule) is interacting with the amine functionally there is no barrier to the proton-transfer. This is consistent with a single-step mechanism. If CO₂ amine complex was solvated entirely by water molecules it is possible that the water molecules could transfer a proton to a base molecule located further away. Alternatively the CO₂ amine complex can remain stable, awaiting the approach of a base molecule.

If water dissociates H⁺OH? or H—OH.

Secondary amines carrying a methyl group has a saturation affect to hydrocarbons by themselves.

MMEA is prone to foaming which tells me if MEA does not, the methyl is the effect.

### Solvent Degradation

Degradation of amines in CO₂ absorption systems can result in the amine molecules degrading irreversibly. The degradation rate can influence the cost of operation.
Thermal
Oxidative
Carbamate polymerization
   Degradation is a problem due to:
Once solvent is degraded, new solvent must be added at regular intervals
Corrosive designed contaminate
More energy absorbed
Become toxic
Foaming
Hydrocarbon loss
Lessened CO₂ absorption
   Degradation products can be basic and acidic products. The basic products are amine molecules of a complex structure. The acid products are small carboxyl acid molecules that are highly corrosive. The carbamate structure created in the protonated form is most vulnerable to oxidation. A solvent which is resistant to oxygen at high temperatures is not going to degrade easily.

### Corrosion

Main cause of corrosion starts with the concentration of carbamate species. Carbamate species often dominate in the ethanolamine systems while they are not formed bad tertiary amine. You must remember when tertiary amines are used for CO₂ removal a promoter is added to enhance which creates carbamates (shuttle-effect).

The corrosion rate is not only a function of the solvent and operating parameters, it can also depend on impurities within the amine system.

Degradation products formed is the main contributor to corrosion rather than the amine itself.

### Foaming

Hydrocarbon saturation is the main contributor to foaming but not the only reason. Temperature, concentration and impurities in the system also have an affect. In an aqueous solution, amines with hydrophobic functionalities are the most likely to cause foaming.

“Methyl Structure Affect”

MMEA—Tendency to foam
MEA—Corrosive and does not cause significant foaming

Ionic solvents have been tried but degrade quickly and have poor regeneration qualities. Put in a water atmosphere weakens their strength and lowers their effect to absorb.

### Conclusions

Carbamates cause corrosion and degradation with contaminants in the chemical atmosphere
Hydrocarbon saturation of amine causes foaming due to vapor pressure change and water solubility.
Absorption qualities are enhanced by basicity and hydrogen availability (possibly together)
Regeneration is enhanced by ease of hydrogen bond strength on water/amine mixture
If carbamate leaves water/amine molecule as a negative structure it is prone to positive charge contaminants. Also, this leave amine molecule with a positive charge and prone to anion connection formation (degradation) and hydrocarbon attachment. The water molecule is also prone to electron depletion during flash regeneration and could become hydrocarbon connected.

In the Three Rivers test, it has proven in sampling the reflux water for pH-hydrocarbon saturation and sulfur species that the electronic charge created by the instant invention has worked as designed.

In the chemical atmosphere the water bonded to the amine structure is basic (approx. 9.5 pH). When the amine is regenerated the water molecule is released or dissociated under flash regeneration. It leaves as pH 7 with no excess protons due to electron depletion. (Refer to core lab report—reflux)

This all means the electronic effect remains bonded to the amine structure (due to unshared electron pair) and recharges the new water molecule needed to bulk up the chemical atmosphere.

### Structures to Consider in Amine Systems

| | |
|---|---|
| Acetic Acid | H₃C—COOH |
| Sodium Acetate | H₃C—COONa⁺ |
| Carbonic Acid | H₂CO₃ |
| Sodium Bicarbonate | Na⁺ [HCO₃] |
| Sodium oxalate | Na₂C₂O₄ |
| Dimethyl Oxalate | (CH₃)₂C₂)₄ |
| Oxalic Acid | (HCOO)₂ |
| Sodium Formate | Na(HCOO) |
| Methyl Formate | CH₃(HCOO) |
| Ethyl Formate | CH₃CH₂(HCOO) |

IMPORTANT! HOC₂H_{f}NH₃⁺CI-DEA chloride (heat stable salt)

This is created by a strong anion reacting to tie up the amine cation

| | |
|---|---|
| Bicine | N,N-Bis (2-hydoxyethyl) glycine |
| Formic Acid | HCOOH |
| Foramide | HCONH₂ |

Carbonic acid is only acid involved in CO₂ removal from natural gas using JD-N>16 ethanolamine. The only difference is when dissociation occurs it will separate as CO₂+H₂O the neutralization of the compound is due to negative charge

### Example

CO₂^{aq}+H₂O←→H₂CO₃— Flash Regeneration H₂O+CO₂

Design of atmosphere avoids H⁺ or negative charged amine due to protonic release. Excess electron atmosphere increases the pH of the water product to increase loading to the water side of the amine solution, stabilize the amine hydrogen's to avoid deprotonation (acidic hydrogen leaving the CO to create carbamates), prevent polymerization caused by opposite charge connection and stabilize cationic contaminates by neutralizing the charge. The negative charged water molecules dissociated during flash generation as HOH to prevent acid formation and saves energy due to less effort for regeneration of amine during CO₂ removal within the stripper (less kinetic heat created.)

### Review of Theory

The instant electromagnetic water solvent, in theory, prevents corrosion of metal surfaces by electronegativity of elements present from deprotonation and electron depleting metals [metals electron affinity becomes stronger than atmospheric compounds].

1. Negative magnetic charge on metal surface

2. Excess electron presence

3. Releases surface tension [magnetic]

The instant electromagnetic water solvent prevents acidic compounds from forming, in theory due to excess electron presence within the solvent atmosphere. One major advantage of this invention is that low cost primary and/or secondary ethanolamine can be utilized with no foaming, hydrocarbon saturation, salt creation, polymerization, degradation of amine, and corrosion is eliminated. There is no need for a carbon filter to remove hydrocarbons, defoamers and anti-corrosives which lower cost of treatment. No corrosion or product loss due to foaming and no degradation of the amine means less downtime, increasing the quality of the final product and released clean 99.6% CO₂ as acid gas which can be sold as a product profit.

### Theory Applied to Amine Systems

Oxygen and acid contaminants entering an amine system by the added water or acid gas entering the contactor can be broken down, neutralized and removed through filtration and/or acid gas stack. The amine/water structure has a repulsive negative design due to electron excess to avoid polymerization and degradation due to salt creation. With the elimination of any possible hydrocarbon saturation to the amine, foaming is reduced to zero. Due to this structure being a multiple amine design it is possible to overload the product causing CO₂ vaporization in the stripper imitating foaming of the amine. This can be avoided by paying attention to operational parameters. Within an amine system energy is replenished to the conductive nano-particles by thermal energy being created by the reboiler. Hydrogen and electrons are replaced during flash regeneration. This has shown RO water is needed more often with the product present within the amine-water mixture. Water dissociation is easily created which avoids hydrogen bonding to CO₂ because of free electron presence during CO₂ release. The electromagnetic force with the liquid consistently controls and affects the lone pairs involved in the water and amine to avoid hydrogen transfer and electron depletion.

Lean amine involved entering the contactor should be 50/50 amine/water at 20° F. hotter than the acid gas to be treated. It has operated with the concentration as high as 74% with no foaming but the viscosity and concentration will cause excess energy used to pump and heat the product. Under 50% it is more energy efficient, but quality loading is hindered.

Using the amine additive, it does take more energy to heat, but this amine mixture holds the heat much better than a normal mixture. This being a multiple amine structure it can load much heavier and the contact surface is much larger. When rich amine/water product enters the stripper a percentage of water dissociates with CO₂ released to create a hydrated electron rich gas preventing deprotonation of the amine and carbamate structure to form with hydrocarbon saturation eliminated and oxidation (electron depletion) prevented, CO₂ can be removed clean to atmosphere, and water content is slightly dispersed. Hydrogen excess to hydrocarbon gases and “oxygen in the negative state” prevents metal corrosion or enriches acid gases leaving. This direction is influenced by the electromagnetic charge involved in the amine solution. Concentration on amine will increase slightly faster than with a common amine/water solution but RO water can by added when needed and will easily become designed as was the past water. This amine/water design has an auto catalytic design where the electro magnetic charge never leaves the amine structure.

### Process for Making Concentrate

In a first preferred embodiment the concentrate is preferably created in a stainless steel reaction vessel with a height twice its diameter. (The dimension could be important due to a reaction swelling of the liquid during chemical reformation.) Product added is measured in volume to accommodate the size of the reactor vessel utilized. The reactor vessel should optimally be an open design to allow unwanted gases and condensate to be removed from the chemical medium. The reactor vessel should have a temperature recorder and means to control chemical medium heat creation. The reactor vessel should have a Ph reader to avoid pH becoming too low at any time. The reactor vessel should optionally have external cooling to avoid the reaction becoming too hot.

Prepare and add silicon lumps of a specific size and space to the reaction vessel taking into consideration the depth of the liquid. 441 silicon lumps, with trace phosphorous, iron and calcium, are preferred. The surface area of the silicon, or surface availability to the liquid, should be utilized fully, as the surface mass to sodium mass involved will be 2-3 times the surface mass to one sodium volume.

Silicon belongs to group UV of the periodic table which has four valence electrons. Elements from neighboring groups such as phosphorous with five valence electrons can be advantageously introduced in small qualities as impurities and fit into the crystal lattice without appreciably disturbing the structure of the electronic energy levels. If phosphorous is introduced, there will be one too many electrons in the conduction band. The number of electrons and holes in pure silicon at room temperatures is about 10¹⁶ per cubic meter, the addition of one e part per million of phosphorous i.e. 10²² atoms per cubic meter increases the number of electrons available for the conduction band by a factor of 10⁽²²⁻¹⁶⁾=10⁶. A few of these electrons are used to fill the holes in the valence band, but the remainder are available for conduction. Adding electrons to the system raises the Fermi level.

Place the silicon lumps within the reactor vessel and mix in a solid NaOH product at percentages to be explained, taking into account that surface area of the silicon is to be fully covered with the solid NaOH. This step is important in order for the first chemical reaction to start near or on the silicon surface. This step should be followed quickly by the next step, in order to prevent any etching of the silicon surface from the high basic hydroxide product.

Distilled water at room temperature is to be added calmly to the reactor over the NaOH/Silicon mixture at a 2/1 water to NaOH volume.

A chemical reaction of water dissociation will slowly accelerate from room temperature to 165° F. (vessel temperature.) When water dissociates, energy is released and it heats the silicon and water medium, as the water dissociates as does the NaOH. When 165° F. vessel temperature is reached, hydrogen is released into the medium dissolving the silicon surface.

The pH of the liquid medium holds at 14⁺, hydroxide ions accumulate, hydrated electrons evolve and energy increases, heating the liquid medium quickly to 190° F. vessel temperature. At this time external cooling may be applied to bold vessel temperature between 165-195° F. to achieve the plasmatic atmosphere needed to create a correctly designed final product.

Holding this stage at 165 to 195° F. vessel temperature can be done by external cooling of the reactor vessel and also, as the liquid lessens, small amounts of room temperature distilled water must be added. This will cool temporarily, but dissociation will cause sudden spikes in heat so the additive should be done cautiously. Too much water added may lower the pH, shock the reaction and end the product batch. Thus, this must be done with caution. People experienced in the art will pickup the timing and amounts. Due to silicon lumps being of all sizes, shapes and surface areas and the silicon being a controlling factor in the reaction it can be a very sensitive control mechanism.

The chemical transfer being accomplished, in theory, is the creation of a hydrogen-electron rich liquid medium, heat absorbed by silicon, sodium-oxide gas off, a dissolving of silicon within a rich hydrogen-electron atmosphere avoiding oxidation, and an absorbing of electromagnetic radiation due to energy release from dissociation. If the liquid medium exceeds 210° F. (boiling point of water) the silicon present in a dissolved state can and will oxidize due to an electron deficient oxygen presence created due to the vapor/gas phase of water. The “electron density of lone pair is non-existent in the gas phase.”

While holding the vessel temperature between 165° F.-190° F. through this entire stage, sodium oxide and water condensate must be able to leave the reaction medium at all times. As reaction progresses the product will thicken and lessen in volume. Room temperature distilled water must be continuously added to maintain the proper volume of liquid in the reaction vessel. This must be done with caution, or discussed, to prevent a sudden pH drop and/or temperature drops. This reaction time will depend on the amount of NaOH added at the start of the reaction. Normal reaction time should be approximate 6-8 hours to termination.

Close to the end of the exothermic reaction water to NaOH should be approximately 6-1 by volume and the product should have a specific gravity of 1.3-1.6, be green in color and have a pH of 14+. At this point the reaction should be calm with small pieces of silicon hydrogenating, floating to the surface, releasing gas and returning to the bottom of the vessel. Warm distilled water to 95° F. (a most active temperature for pure water) and add to the liquid to a 1.23 to 1.23 sg. Let set for 24 hours. Separate the liquid from excess silicon. Product now must be sealed from atmospheric air and allowed to stabilize for 7 days.

### Final Concentrate Structure

### A Preferred Embodiment

Specific gravity: 1.23-1.25

Clarity: clear yellow liquid

pH: 14 or 14+

10% silicon content by mass volume

Electromagnetic charge of between 280-480 nm within the UV visible spectrum

In theory water molecules are affected by an presence of an electromagnetic force weakening the lone pain repulsive force, changing bond angles to linear, preventing hydrogen bonding, lowering water cluster size, raising pH due to excess electron presence. Water molecules become mono-polar hydroxide negative-Hydrogen neutral in a micro-cyclic water cluster design.

### A Final Product—Diluted Concentrate

Once the concentrate reaches the final structure and is stabilized it is only a concentrated additive. It does not have its preferred use in a concentrated form. Adding concentrate to de-ionized water at a ratio of about 99 to 1 or higher, creates a useful product and restructures the de-ionized water molecules to become a product of preferred use. In reality the water added becomes the product to design amines, alcohols and other water structures by interfering with internal dispersion forces of molecules coming into contact with this electromagnetic water or “magnetized” water medium. A condition desired for creating the magnetic water medium is having the concentrate and de-ionized water at the same or close to the same exact temperature. Concentrate should be added to the de-ionized water. Sufficient time after addition should be allowed for the concentrate to disperse and align within the water medium. The longer the time within the water medium the more exact the product becomes. The water used should be demagnetized, or (de-ionized), for the electromagnetic formation to best succeed. One desired mixture would be “1 Si to 10,000H₂0 for 410 nm.

### A Preferred Final Step, a Process to Design Amine Solutions for Plant Conversion

### Description of Process

To achieve the chemical design of a stabilize ethanolamine, as discussed above in this invention, a preferred process is a five step process, taking place in a glass lined, stainless steel pressure vessel with a steam-jacketed external heat source.

Controls preferred and used in this process are:
1) temperature thermocouple
2) ORP meter
3) volume meters on inlet lines
4) pressure gauge
5) pressure relief value
6) one-way valves on inlet lines
7) level reader
8) CO₂ reader on gas exit
   Vessel should be gas lined to prevent any metallic contamination entering the chemical medium.
   Vessel should be a pressure vessel to maintain needed pressures for the chemical medium.
   Vessel should be a pressure vessel to prevent atmospheric air contaminating the chemical medium
   Vessel should have an external heat source to gain and maintain temperatures needed for the chemical medium.

### Step #1

A specific volume of de-ionized water is pumped into the reactor vessel. The pressure relief valve is opened during the pumping process to avoid pressure build-up within the vessel. The de-ionized water is metered during pumping process to achieve the desired volume. Once the desired volume is achieved the pressure relief value is closed and the de-ionized water is heated to a temperature of 95° F. and held at this temperature for 4 hours. This step is important to the final product to adjust the water molecules to a desired cluster

### Step #2

Nitrogen gas is injected into the upper atmosphere of the reactor vessel. This is done slowly to prevent any surface disturbance of the de-ionized water. Once pressure within the reactor vessel reaches approximately 10 psi the pressure relief valve is opened slowly to force atmospheric air from the reaction medium. This is continued till the gas meter registers no CO₂ exiting. The pressure relief valve is closed and the nitrogen gas is injected till the reaction medium pressure reaches 35 psi. This step is important to the final product by keeping unwanted CO₂ being involved in the chemical equation.

### Step #3

A specific volume of concentrate is added into the reaction medium by a pressure pump near the bottom of the reactor, bleeding pressure from the pressure relief valve, maintaining the 35 psi desired for the chemical medium. The ratio of concentrate and de-ionized water must be equaled to 1 part concentrate to 99 parts de-ionized water. Once concentrate is filly injected into the reactor vessel the reactive medium is stabilized and held at 95° F. and 35 psi for 6 hours. This step is important to creating the final product due to temperature and pressures are crucial to water cluster separation and realignment in the presence of a magnetic charge.

### Step #4

Once the water restructuring medium stage is completed, a proprietary amine mix (a design of one or more ethanolamine structures at a percent per amine choice) is added to the reactor vessel. This is done slowly, holding temperature at 95° F. and pressure at 35 psi by bleeding gas atmosphere through the pressure relief valve. The amine added will enter the reactor vessel near the bottom into the treated de-ionized water to solubilize without gas bubble creation. This mix of ethanolamine to treat de-ionized water mix is preferably of equal volume. This mix is let stand for 12 hours holding pressure at 35 psi and temperature at 95° F.

### Step #5

Once the final 12 hours of reaction time is complete the temperature and pressure are slowly terminated from the reaction medium. This is accomplished so or not to disturb the surface of the amine-water solution. Once the pressure is fully released from the reactor vessel and temperature has equaled atmospheric temperature outside the reactor vessel the solvent may be removed and packaged for storage and/or transport.

This amine will be a “multiple design amine” using a primary and/or secondary amine structure with a high base magnetic water structure.

The final product should have a pH of 11.5 to 11.7. It should have an above average viscosity and an increase in surface tension (interfacial,) slightly higher boiling point and a magnetic charge on the negative side. These characteristics establish that the amine has stabilized.

### Concentrate Test Results

The following tests were performed upon the concentrate, to confirm its characteristics.

A lab was provided with four 10-ounce samples, two from the same batch, referred to as duplicate samples. The other two were from different batches. The directions were:

A. Filter one of the duplicate samples as received with medium porosity Whatman filter paper.
Then test each of the three, 10-ounce samples, as received from John DeLoach, plus the fourth duplicate sample “filtrate,” as follows:

B. Analyze samples and filtrate for:
1. color (with attention to clear yellow color or not.)
2. To the extent that you have a test, determine the extent to which a sample is a “colloidal suspension,” i.e. a suspension of particulates as opposed to a solution or a mixture.
3. pH
4. Specific gravity or density
5. FTIR scan—with attention to any possible silicon hydrides.
6. To 10 grams of the filtrate and the three samples add 3 or 4 pellets of 100% NaOH. Shake until the pellets dissolve and observe . . . (with attention to as whether or not a gel forms.)
7. To 10 grams of the samples and the filtrate, each, add 10 drops of 30% hydrogen peroxide (H₂0₂) and observe . . . (with attention as to whether or not a gel forms.)
8. On the filtrate from step A, as well as on the three samples, run % sodium and % silicon by ICP (Inductively coupled plasma)
9. Evaporate the water from 10 grams of the three samples and the filtrate each, by boiling on a hot plate until most of the water is gone. Then place in an oven at 130° C. until all the water is gone. Quickly weigh the remaining solids before the NaOH has time to absorb moisture from the atmosphere. Divide each residue in half, creating 2 sets of 4 residues each. Re-weigh one set and put this set aside, open to the atmosphere, for 24 hours, and then reweigh again (to test for absorbed water.)
10. Also, on the other set of resides remaining after all the water is gone (step #9), quickly run FTIR scan (with attention to silicon hydride.)
11. Upon the set of residues not put aside also, compute percent solids by weight with respect to each initial sample. Also, of these solids, compute percent sodium and percent silicon (by IPC).
12. Write a final report with the results from the test. No spectral interpretation is necessary.

In regard to the results, it was desired to know whether the samples of the product received were, or were not, characterized by:
i. a colloidal suspension;
ii. of clear yellow color;
iii. having a pH of 14;
iv. having a specific gravity of between 1.23 to 1.25 at 20% solids;
v. not a metal hydride;
vi. having a sodium to silicon ratio, by weight, of approximately 1 to 1;
vii. and having a solids to liquid ratio of approximately 1 to 4 or 1 to 5.

The following samples were tested:
6A Nov. 28, 2005—Filtrate
6A Nov. 28, 2005—Duplicate
9A Dec. 17, 2005
9A Dec. 17, 2005

In addition to the report by the Lab, there is also a report from a Lab for the FT-IR scans requested. See attached FT-IR test results.

In regard to the results, the Lab determined the following:
1. colloidal suspension—There is not colloidal suspension in the material (filtered at 0.7 um)
2. there is a clear yellow color present
3. the pH is 14 in all four samples
4. specific gravity ranges between 1/23 to 1/25 at 28% (not 20%) solids
5. metal Hydride—this issue is covered in the attached FT-IR report from Laboratory—basically to effect of none present
6. the Silicon to Sodium ration, by weight, was about 1 to 1.3
7. the solids to liquid ratio is 1 to 3.6
8. the samples did not gel with the addition of Sodium Hydroxide
9. the samples did not gel with the addition of hydrogen peroxide
10. water gain after % solids test rang from 0.35-0.42%.

See Test Results, Table A.

### Three Rivers Test

### Amine Gas Treatment Plant

The main objective of this test was to operate a full size gas treating facility, utilizing a new redesigned ethanolamine in accordance with the instant invention (from Cerulean Energy Solutions.)

The gas treating facility chosen was the Duke Energy Field Services located near George West, Tex.

In the past, this plant has been a problematic operation, small in size, (has only been operating 30 mmcfd) but has the capacity of treating 90 mmcfd.

The Cerulean Energy Solutions test used the Three Rivers Plant, DEGS-NGL extraction facility, which is located near George West, Tex. in the Central Texas Asset Area. The facility includes two cryogenic plants—the “A” plant rated at 30 mmcfd and the “B” plant, rated at 90 mmcfd. However the purpose of this test is addressing the operational concerns of the “B” plant only. The “A” plant at this time is not in use.

The Three Rivers facility is setup for NGL extraction which involves the treating and dehydration of the gas prior to the cold plant.

The amine system was put together by South Texas Treaters utilizing surplus equipment not designed as a package plant.

### The Major Components are:

Amine Contractor/Inlet Scrubber (integrated)
Amine Contractor Overhead Scrubber
Flash Tank
Lean/Rich Exchanger
Amine Still Column/Reflux Accumulator (integrated)
Amine Reboiler
Lean Amine Cooler/Reflux Condensers (shared)
Johnson Screen Filter
Amine Sock Filter
Amine Charcoal Filters
Amine Surge Tank
Amine Booster Pumps
Amine Circulation Pumps
Amine Reflux Pumps

### Mechanical Flaws Noted:

Amine Contactor—minimal gas flow or circulation rate can upset the tower hydraulics.
Amine Still—undersized to system—not designed for high flow rates at low solvent concentration.
Amine Coolers—serves for cooling of lean amine and reflux water using two bays of exchangers on the same set of coolers. This can be problematic during the more extreme heat of the summer or cold of winter, a variable speed fan is set up to control lean amine temperature but often fails when slowed.
Surge Tank—can not gain more than 19 gpm at this time. It is located between the booster pumps and circulating pumps. Ideally, it should be located upstream of the booster pumps. They are currently running two booster pumps to maintain the surge level.
Make-up Water—make-up water is at present being added to the reboiler. Make-up cold water into a 260° F. reboiler upsets the still column stripping action and makes the reboiler work harder for the duration of charged water.
Product Treating—The “B” plant should be set up to routine amine to the Product treater and back for regeneration.
Chromatograph—four streams are being monitored by one chromatograph. They are dead ended into the chromatograph which creates lag time between operational changes and the results of the change. This will turn out to be a headache for operators during this testing protocol.
Amine Reboiler Blanket Gas—the blanket gas regulator is set to high or is leaking through to acid gas stream.
Reboiler Temperature Control—this is currently set up to be controlled by both the reboiler and the still overhead. It is better not to let the overhead temperature control the water flow to the reboiler. This could result in higher than desired temperature in the reboiler, thus higher energy costs to operations.

### Reflux Level Control—

Pressure Control—All three of these process variables swing, drastically

### Reflux Rate—

Inlet Pressure to Plant—No control can have sudden pressure drops or increases affecting plant operations, (hydraulics)

Operations experienced numerous mechanical and chemical problems in the past, primarily related to hydrocarbon absorption which in turn caused foaming, as evidenced by the frequent carryovers, high differential pressures across the contractor, amine losses and hydrocarbon losses due to inadequate CO₂ removal. The solvent in use in the past was Ucarsol CR-402. Attempts were made to overcome these problems by raising the concentration to 40-50%, injecting anti-foamers, frequent Charcoal Filter changes, increased circulation rates, and venting and draining the reflux accumulator. The solvent failures resulted in significant production losses, excessive corrosion, excessive emissions, averaged operational flow of approximately 30 mmcfd since April 2004 due to operational problems and gaining inlet gas from sales.

Taking into consideration past operational malfunctions incurred at the Three Rivers Facility, chemical solvents used, contaminants in gas stream to be treated, and parameters available with all mechanical flaws assessed, Cerulean Energy Solutions decided to introduce a stable 50% DEA product.

The original choice was a:
10% MEA
40% DEA
   DEA by itself may not be able to remove all CO₂ as desired. The reason for not going with this mixture, however, was that during a test run it would be better to go with only a one amine mix for a more accurate test analysis. We were confident that stabilizing DEA would create a higher loading DEA final product and would accomplish what we needed. A 50% mixture was designed for 1/1 stabilization with water. If DEA can stand-alone in removing CO₂ to spec, we knew that by adding MEA would only improve the removal in the future.

### Summary

This conversion of the Three Rivers facility was initiated in mid September 2005 and has been carried on to the present. At times we had weather in the highs of 90 and probably some of the coldest weather that the Three Rivers facility would encounter. Atmospheric conditions played a major part in operational control during the test run.

The Cerulean Energy Solutions objective was accomplished to the parties' satisfaction in every aspect of the product design and use.

### Eliminating Foaming

Foaming elimination was one of the main objectives. Foaming is a sign of Hydrocarbon Saturation, which shows acid creation (hydrogen transfer,) degradation of amine by HSAS to corrosion and product loss due to foaming.

### Running of High Concentration

At the initiation of the product to the Three Rivers facility, the amine concentration was designed at a 50% DEA concentration and our parameters were to operate at all times with a concentration between 50% to 60%, with a flow as low as possible to remove all CO₂ contaminations from the gas steam. All was accomplished to an extent, during this test, but due to small mechanical problems, atmospheric temperature swings and inlet flow changes, we exceeded this 74% high. I believe that the concentration has never been lower than 50% because little product or very little product has been added since its inception.

### Low Circulation of Lean Amine

At times during the test, we have succeeded in lowering the circulation rate to accomplish low CO₂ readings, but due to this being a new product, the control operators were skeptical or afraid to push these parameters forward.

A senior operator had initiated and accomplished this test for us by slowly lowering the circulation, and watching carefully for CO₂ content in the final product. In the beginning he noticed that content started to climb, but once the low end was held for a short period of time the CO₂ began to fall and the end result was a lower CO₂ content than the high flow in the beginning.

This will not be a problem in the future due to the fact that at present we have initiated a 100% DEA mix for this test. Adjustments will be made for a more specific amine mix to address these concerns.

### Temperature of Lean Amine

At the start the parameters for temperature were left to the operators' discretion. This was done because the past products that they had dealt with were very touchy on the high end temperature, which caused multiple upsets within the amine system.

We did explain that if necessary this product could be run as high as 165° F. without failure, if needed to cure an upset and return online quickly. An incident happed to prove our position in early January. A cooling fan failed and the lean amine reached a temperature of 180° F. before vaporizing in the still tower. The senior operators quickly corrected the upset and stayed online and operational. They (senior operators) have related to us that they have found this product to however optimum temperature range where the lean amine circulation has been 135 to 145° F.

### Product Loss

To date we have seen little product loss during this test. Product loss can be detailed in four different directions.

a.) Acid gas

b.) Reflux water

c.) Final product contamination

d.) Maintenance (pigging filter changes, etc.)

Foaming in an amine system is the main sign of the start of product loss. We have operated now for months and have seen no visible or recorded foaming to cause spill over into the acid gas system or reflux system. Filter changes have slowed to a minimum.

Reflux and acid gas has been analyzed by an independent lab and has shown little carry-over. Hydrocarbon saturation is non-existent from the initiation of the product amine test.

### Maintenance and Filter Changes

Mechanical failures due to an amine problems have not been recorded since the onset. In the first two weeks, the filters of the sock and Johnson filter system were frequently changed. Since then, filter changes have been less than normal and sporadic, and the carbon filter has never been put on-line. I believe that this is due to the prior silicone foaming additives that were being cleaned from the flow system which took two weeks to accomplish.

### Conclusion

With months of operation at the Three Rivers Facility converted to a Cerulean Energy Solutions ethanolamine product in accordance with the on start invention, all past problematic amine weaknesses have been overcome, which should prove with no question that a stabilized ethanolamine can be the amine of choice in any plant with past problems.

Tests at monthly intervals, using independent analytical facilities has shown without a question:

On spec gas/LNG

No loss of solvent

No corrosion

No salt creation

No foaming

Lean Amine can operate at a high temperature of 170° F.
Lean Amine can operate at high concentrations of 74%

No need for additives

No Hydrocarbon loss to reflux/acid gas

No Hydrocarbon saturation (no need for carbon filters)

Less other filter changes (Sock & Johnson)

Significant increase online time

Taking past records of the Three Rivers Facility, analyzing information and comparing with the months of operation with CES ethanolamine in the same facility, the conclusion has shown that, Cerulean's stabilized DEA has out performed the Ucarsol CS 402 product in every aspect.

We have seen and recorded all mechanical upsets that Cerulean's DEA had to handle and it performed to perfection.

Filter changes have almost been unnecessary, to the extent that the carbon filter has never been put on line as of this solvents inception into the plant amine system. There has been no solvent loss (except for mechanical repair spills) and foaming has been non-existent, even during high concentrations, as high as 74%. The concentration from the onset has averaged between 55-65% during operation.

The reflux water has been monitored daily and has been clear and free of odor since onset and when analyzed after 90 days of operation showed no noticeable contaminants. Acid gases have also been monitored and have been free of hydrocarbons and amines (99.358% CO₂.) On Dec. 27, 2005 analytical reports showed hydrocarbon but it was found that blanket gas had leaked into the acid gas line to contaminate the final acid gas sample.

We have had to keep the circulation rate high to stay in gas spec throughout the first four months, but this seems to suit the solvent capability we chose at the start. This can be corrected in the future.

Corrosion coupons were installed 30 days into the conversion and were removed 90 days later. They have shown little corrosion had taken place during operation. With all the bumps and mechanical upsets during the first 4 months of operation Cerulean Energy Solutions ethanolamine has overcome all of them and had yet to degrade to any state other than what was initially installed.

Operators of this facility have been enjoying operating this facility ever since the conversion due to its case of control and its wider parameters of control. Once they understand what it can do, they will utilize it to its full potential. At this time they still have a mind-set of past products and problems caused by its instability.

This test supports the theory that the water involved in the chemical atmosphere of a gas stream and amine presence is the molecule to affect to avoid amine degradation in removing CO₂+H₂S.

This test supports the theory that Hydrogen transfer and electron depletion is the creation of all problems indirectly effecting amine quality, loading regeneration, acid creation, foaming, in turn hydrocarbon saturation, corrosion, solvent loss and creation of Heat Stable Amine Salts. With this scientific information MEA and similar primary amines can be the amine of choice in the future. These amines, being of a stronger Lewis base, will absorb/desorb at ease. With hydrogen stabilized no carbamate creation should take place, which is the theoretically start of the domino effect of all of the other problems to be avoided.

See Three Rivers Test Results, Table B.

### Summary

### Prevention of Corrosion in the Gas Stream of an Amine Plant

To summarize, this invention product prevents corrosion as theoretically surmised, in a two fold chemical manner. The invention, it is believed:

(1) affects water structure by dispersion force to stabilize the water molecule, releasing a paramagnetic oxygen to form a substantially non-water soluble and electrically insulating compound on the surface of the metal into the pre-existing thin oxide layer substantially non-electrically conducting, relieving any surface tension;
(2) creating a chemical atmosphere within the amine system which prevents any deprotonation or electron depletion to avoid an unwanted chemical direction, by
creation of carboxylic acid
polymerization of amine
anion creation of contaminants
additives need ex: glyoxal/foaming inhibiters/corrosion inhibiters
avoiding metal solubility, ex: iron

### Buffered Electron pH

### Final Addition Test

### Test Protocol Jul. 24, 2006

### Products Used—Anyhydrous Ethanol (Denatured)

Raw Distillalte from Wellhead Bleed Valve (LPG)

### Distilled Water

### Inventive Product

Direction 600 ml distilled water and 6 ml inventive product fuel additive mix is added to 3 gallons of anhydrous ethanol. This mixture is given ample time to disperse and reform. This stabilized hydrous ethanol product is then added to 1 gallon of the raw distillate and let stand for 24 hours in a sealed container. This will give ample time to reform into the desired fuel structure.

The fuel mixture was removed on July 25/6 and visually tested. Observed was a clear, near odorless, liquid with a slippery feel that did not evaporate quickly. This fuel was bottled, sealed, at sent off for analysis at Texas Oil Tech laboratories in Houston Tex.

### Results:

OCTANE—105

CORROSION—1A

BTU/LB—12,222

WATER CONTENT—2.52%

FLASH POINT—−11° F.

VAPOR PRESS 3.8

AUTOIGNITION TEMP 410° F.

### Explanation of Test Results

105 Octane—Fuel with no lead, MTBE, MMT, AROMATICS, and Olefins make an environmentally safe, clean burning fuel with high performance fuel qualities.

Corrosion is A (1a), which is the best result possible. With 2.52% water and 48% ethanol involved.

Energy Content—above average for this fuel structure.

Flash Point—is an exceptional −11° F. Ethanol's flash point is normally 50-66° F. This is important in cold starts and clean complete combustion.

Vapor Press—an exceptionally low 3.8 normal fuel is 9 or higher. This is important in evaporation polluting the environment and operating in warm climates to prevent vapor lock and fuel boiling.

Autoignition Temp—a desired 410° This is important in power, carbon deposits, and engine pre-ignition problems.

Note: Viscosity and lubricity has been increased for improved atomization and fuel movement which will increase fuel economy.

This fuel design is a clear, near odorless liquid, slightly more viscous than normal gasoline, slightly higher specific gravity with a slightly more lubricating quality.

Water tolerance has been physically tested, and has shown water absorption of at least 5% by volume before the hydrocarbon and alcohol separate. WE have seen as high as 10% in some testing but never less than 5%.

### Sunoco GT Racing Gasoline (Ethanol)—The Comparative Product

Sunoco GT is an unleaded racing gasoline designed for high performance racing cars, muscle cars, street rods, motorcycles, karts and marine applications. With the highest octane rating of any US street legal fuel, SUNOCO GT will allow significantly increased boost levels in supercharged or turbocharged applications. It contains no metallic compounds to harm catalytic converters or oxygen sensors. It has a high oxygen content to enable a richer mixture resulting in more power and rapid response of the engine. The 105RON and 95MON provides protection against knock up to compression ratios as high as 14:1.

### Typical Applications

All events where gasoline is used as fuel. High performance vehicles, turbo charged vehicles, Water crafts and high revving motorcycles
Racing cars, motorcycles, karts, jet skis
Modern high performance sports care
Turbocharged cars
Performance motorcycles

### Outstanding Features

105 Research Octane Numbers
95 Motor Octane Numbers
3.5 oxygen
Contains no lead additives
Low vapour pressure for protection against vapour lock
Controlled mid-range volatility for excellent warm-up, acceleration and driveability
Keeps carburetors and fuel injectors clean
Resists gum formation
Burns extremely cleanly to resist deposit build up
Oxidation and corrosion inhibited for longer shelf life
Complete conformity and quality allows precise engine tuning

### Description

SUNOCO GT racing gasoline is formulated from high octane blend stocks and selected additives. It has a substantially increased protection against detonation compared to normal ‘pump’ fuel under high revs and in heavily turned engines. Its oxygen content improves performances for engines operating with air restrictors. Its fast burning properties makes the SUNOCO GT an excellent choice for high revving two stroke engines. It is also compatible with all two-stroke synthetic and mineral based motor oils.

The manufacturing process of this fuel is designed to provide a fuel that is 100% repeatable and that will perform the same batch after batch. Every batch s tested to meet SUNOCO's stringent quality control procedures to allow precise engine tuning for maximum performance. Sunoco GT contains ethanol as the oxygen carrier.

SUNOCO GT burns extremely cleanly and therefore leaves little or not deposits, allowing maximum engine power for the duration of the engine life. The high quality stocks used in the SUNOCO GT make the fuel very stable and resistant to gum formation. A multifunctional additive package provides carburetor and fuel injector detergency and minimizes the formation of intake valve deposits. Antioxidants and corrosive inhibitors promote stability and longer self life. It does not contain any lead additives.

Due to its raw material make-up, Bio Diesel is essentially free from sulfur and aromatics. The emission of particulate matter is reduced 55% from petroleum diesel and carbon monoxide is reduced 43% when B100 is used. Bio-Diesel contains no nitrogen or aromatics and typically contains <15 ppm sulfur. Bio-Diesel contains 11% oxygen by weight, which accounts for its slightly lower heating value (energy content) and its low carbon monoxide, particulate matter, soot and hydrocarbon emissions. The energy content of Bio-Diesel is roughly 10% less than No. 2 diesel; however the fuel efficiency is the same as petroleum diesel fuel. Bio-Diesel has a higher cetane than petroleum diesel.

When compared with the other significant renewable fuel, bio-diesel has two distinguishing, important characteristics. Bio-diesel has a very positive net energy has a very positive net energy gain, with a 3-4 to 1 ratio, which is much higher than that of a ethanol. Also, using bio-diesel in diesel engines has always been a very positive experience with no concerns expressed about engine problems. The higher lubricity characteristic than Ultra Low Sulfur Diesel, which is being produced in anticipation of the national, 15 ppm sulfur standard to be imposed in the middle of this decade, make Bio-Diesel a superior performing fuel. While bio-diesel has yet to capture a large portion of the 55 billion gallons/year of petroleum diesel consumed in the USA, in the European Union more than 900 million gallons of bio-diesel was consumed in 2002.

Bio-Diesel is considered a qualified Alternative fuel by both the US-EPA and the US-DOE and a fuel additive under Section 211(b) of the Clean Air Act. As such it may be used to meet the EPACT vehicle standards imposed on federal, state and agency fleets. Federal Mandate 13149 requires a 20% reduction in fossil fuel use by federal fleets by 2005. Bio-diesel represents the easiest method for fleets to meet this mandate.

Creating ethanol is a two stage system. Distillation to hydrous ethanol which is 94.5% is the first stage. The second stage is to remove the final water content which is another process needed, the molecular sieve, which adds cost and less volume. With the use of the instant invention the molecular sieve process stage is no longer needed to create a soluble stable ethanol fuel.

Anhydrous ethanol is soluble with a hydrocarbon but if a small amount of water enters the equation they become insoluble.

Today's ethanol-fuel mixture sold at fuel stations at present are blended near or at the station to avoid contamination/separation. Transportation and storage of an ethanol-fuel mix is not attempted due to this dilemma. The instant invention affects the internal forces of the ethanol “in turn” water present to change the solubility qualities to prevent this occurring.

Tests were done to show effect of instant invention in bio-fuel technology. An anhydrous ethanol (denatured) was used. 5% distilled water was added and 0.05% by volume of the instant invention. This mixture was let to set for 12 hours in order to stabilize the molecular structure. One this product was stabilized an additional 10% distilled water was added and sent to Texas Oil Tech for analysis.

### Results

1. Octane values exceeded 180 octane
2. Corrosion was much better than hydrous ethanol and can be improved with less water content.
3. Energy content was normal for ethanol but would be increased drastically with 10% water removed.
4. Flash point was equal to anhydrous ethanol and can be lowered further by addition of a small amount of LPG
5. Freeze point was −80 even with 15% water content.
6. RVP was extremely low at 3.22 LPG addition will increase this value slightly.
7. Water content was 15% by volume and was still stable, combustible and “soluble” in a hydrocarbon.
8. Lubricity was better than any gasoline on the market even with 15% water content

Problems with using hydrous ethanol as a fuel with past science was that it was highly corrosive, had poor lubricity, a high flash pint and a low energy content. We have proved by these test results that these problems are now a thing of the past.

To create an ethanol fuel, prior art has shown only anhydrous ethanol could be mixed with a hydrocarbon fuel. Even when mixed, if it took on 600 ppm of water it would become insoluble and separate. This fuel of Test #2 was the hydrous-water ethanol used in Test #1 and 87 octane pump gasoline. This mixture was a clear, slightly yellow liquid.

All fuels can be created from hydrous ethanol and animal fat esters based on the instant invention. A key effect for all fuels is believed to be reforming a hydrous ethanol to be used as the catalyst for all other fuels. This hydrous ethanol after treatment is believed to have bond structure adjusted, as well as for all other fuels. This hydrous ethanol after treatment is believed to have bond structure adjusted, as well as solubility qualities altered, viscosity, density, vapor pressure and energy content affected and due to surmised new internal dispersion forces, becomes non corrosive when added to hydrocarbon, water, vegetable oil or ester fats and which should in turn affect their internal bonding. Benefits of animal fats AFME:

1. No major contribution to the greenhouse effect (CO₂ balance)

2. High cetane number

3. Lubricity

4. Particulate emission better than RME

We can take 60 octane naphtha from the refinery and mix it with treated hydrous ethanol at a low percentage to create a stable clean burning high octane gasoline.

We can take high sulfur diesel and mix it with treated hydrous ethanol and AFME to create a superior low sulfur diesel product.

We can mix hydrous ethanol to gasoline or diesel to create a soluble stable product.

We can eliminate essentially all corrosion in crude oil of any kind at an economical price. Testing Report from Mar. 14-Mar. 15, 2006

### Introduction

This report documents emissions and fuel economy data from a 425 HP tractor that was tested in March of 2005 using a heavy duty chassis dynamometer at the University of Houston Diesel Vehicle Research and Testing Facility. The tractor was tested with 3 different fuels: 1. Off-road diesel fuel, 2. Off-road diesel fuel with Fuels of Texas additive. 3. B100 Diesel fuels with Fuels of Texas additive. The purpose of this work was to measure the reduction in exhaust emissions (particularly PM) and any other changes achieved by using the Fuels of Texas additive. BI O Fuel without additive was not tested.

### Test Procedures

The objective of this work was to generate emissions and fuel economy data from a tractor with a total simulated weight of 41,420 lbs; this weight includes the tractor, trailer with a load of 10,000 lbs, and a driver. The specifications of the vehicle tested are given in Table 1. An on-road coast down with the loaded vehicle was done to determine the target parameters for the dynamometer. The road load curve and target parameters are given in the appendix. The drive cycle that was used was designed to simulate highway driving (50-60 mph) with an initial acceleration from 0 mph to 60 mph, the “highway drive cycle” is shown in of three snap-throttle tests were also done for each fuel. During the snap-throttle constant dilution ratio. The snap-throttle tests were designed to create maximum PM emissions, by idling the vehicle for 10 minutes and then accelerating rapidly at full throttle in 4^{th} gear until the shift pint.

Prior to testing, the vehicle was given an oil change and the tires were replaced. The test plan for the project is given in Table 2. During all the highway drive cycle tests emissions of NO, THC, CO, CO₂, O₂ and total PM were measured.

### Summary

Table 5 summarized the reductions emissions as well as the reductions from baseline (fuel 1) for fuel 2 and 3. Fuel 2 (off road diesel additive) showed a 0% reduction in NOₓ and an 8% reduction in particulates during the highway drive cycle and a 51% reduction in particulates during the snap throttle test as compared to Fuel 1 (off road diesel). Fuel 3 (B100 diesel with additive) showed a 2% increase in NOₓ and 64% reduction in particulates during the highway drive cycle and an 88% reduction in particulates during the snap throttle test as compared to Fuel 1.

Engine & Compressor Systems, Inc (ECS) was retained by Fuels of Texas (FT), Mr. John E. DeLoach to evaluate the application of (ft's) JD-N-16 ethanolamine fuel additive to B100 bio diesel fuel. ECS contracted with the City of Houston to use the University of Houston's (U of H) Diesel Vehicle Research and Testing facility. The documentation produced by the City of Houston and U of H shows ECCS as the prime contractor testing agent. References to ECS additive refers exclusively to the use of Cerulean's JD-N-16 ethanolamine fuel additive.

The purpose of the testing was to determine the potential particulate matter reduction (PM) that off-road diesel fueled equipment could expect by using the blended B-100E fuel. The results based on PM reduction when compared to number two diesel were significant. “See Table 6 of the Lab's report.” The most significant reductions occurred in carbon monoxide total hydrocarbons and particulate matter. The most dramatic reduction was measured during the snap throttle test. The reduction in particulate mass was 88% as compared to the baseline fuel. The results of the baseline text clearly indicated the ability of the Cerulean additive to chemically blend with biologically produced fuel oils.

To certify the physical properties of the blended B-100 E⁺ fuel, ECS retained Texas Oil Tech Laboratory to perform ASTM protocol test on the blended fuel. The results are based on the following blend:

| | % |
|---|---|
| Compound: | by Volume |
| Bio-Diesel: Methyl Soyate, Rapeseed Methyl Ester, Methyl | 77.52 |
| Tallowate, Ethanol | |
| Ethanol: | 19.38 |
| JDN-16⁺ | 1.94 |
| Glycerin | .68 |
| DI Water | .48 |
| Cetane number (ASTM D 613) | 42.0 |
| Viscosity, Kinematics @ 40° C. ASTM D445, cST | 2.82 |
| Ash Content, ASTM D 482, wt % | <0.001 |
| Lubricity (ASTM D 6079 HFRR) Average ware scar, uM | 250* |

*This is compared to No. 2 Diesel at 360-415 is excellent.

In conclusion, the JD-N-16 ethanolamine fuel additive when blended with biologically produced fuel oils produces exceptional engine performance. The ability to allow water to emulsify with bio-fuel and maintain excellent lubricity is extraordinary. Additional performance testing with an engine class equipped with adjustable valve and fuel timing will produce significant reductions in NO^{x} would be in the 20-35% range.

For off-road application Cerulean's B-100 E is a market ready product. This fuel for off-road application is superior to any product that is in the current fuel inventory.

See Test Results, Table C.

### Alternate Methodology

A second improved method for making the concentrate, as of the filing date, includes mixing silicon and caustic by weight ratios. Approximately two units by weight of silicon is mixed with approximately one unit by weight of caustic, NaOH. For instance, two pounds of silicon would be mixed with one pound caustic. Preferably the silicon and caustic are mixed in three equal one third batches. Thus, a preferred technique is to blend, in equal one thirds, the above ratio of silicon and caustic in an open vessel.

Then for eves approximately two pounds of silicon and one pound of caustic in the reaction vessel, approximately one gallon of distilled water at ambient temperature is added. A reaction starts immediately. The internal temperature of the reaction mixture is preferably monitored. This internal temperature preferably would not be allowed to exceed approximately 300° F. Control of internal temperature below 300° F. can be maintained by carefully adding additional room temperature distilled water. At the end of approximately 6 to 8 hours the reaction will be substantially complete. About one third of the silicon will not have gone into solution. It will have formed, or will form, a sediment on the bottom of the vessel.

It is preferable to let the liquid sit open for approximately 24 hours. Then the liquid should be separated from excess silicon sediment by pouring the liquid concentrate out of the vessel leaving the sediment. The concentrate should then be sealed from atmospheric air for at least 100 hours.

A useful product can be made from the concentrate by combining approximately one part concentrate with 99 parts deionized water. (It should be understood by one of ordinary skill in the art that deionized water implies de-mineralized water.) Tests indicate that a useful product can also be formed by combining one part concentrate with 85 to 100 parts deionized water.

Tests further indicate that a concentrate of at least an amber color and of a pH of at least 12.65 is useful for some applications. Preferably the color of the concentrate is a clear yellow and the pH is at least 14.

It is speculated that the above discussed “treated water,” produced by the instant invention, could be described as water wherein the oxygen to hydrogen bonds have been significantly strengthened. It is speculated further that the surface tension of the water in the product has been significantly affected. Such “treated” water, when added to an amine solvent for a treatment plant application, has the apparent effect of stabilizing variations in the pH of the resultant solvent during treatment. The pH swings appear to be limited to the basic side of the scale.

Reference to “treated” water herein may be more appropriate at this time than reference to “doped” or “magnetic” water. The existence of “magnetic” water is difficult to substantiate.

The foregoing description of preferred embodiments of the invention is presented for purposes of illustration and description, and is not intended to be exhaustive or to limit the invention to the precise form or embodiment disclosed. The description was selected to best explain the principles of the invention and their practical application to enable others skilled in the art to best utilize the invention in various embodiments. Various modifications as are best suited to the particular use are contemplated. It is intended that the scope of the invention is not to be limited by the specification, but to be defined by the claims set forth below. Since the foregoing disclosure and description of the invention are illustrative and explanatory thereof, various changes in the size, shape, and materials, as well as in the details of the illustrated device may be made without departing from the spirit of the invention. The invention is claimed using terminology that depends upon a historic presumption that recitation of a single element covers one or more, and recitation of two elements covers two or more, and the like. Also, the drawings and illustration herein have not necessarily been produced to scale.

What is claimed is:

1. A concentrate comprising:
sodium,
silicon; and
water;
characterized by a sodium to silicon ratio of less than 1.0 by weight, by an absence of significant metal hydride, by a color of amber to yellow and by a pH of at least 12.65.

2. The concentrate of claim 1 formed by initially combining sodium hydroxide, silicon and distilled water in a weight ratio of approximately 1 unit to 2 units to 8.3 units, respectively.

3. The concentrate of claim 1 having a pH of at least approximately 14.

4. The concentrate of claim 1 having a specific gravity of approximately 1.23 to 1.25 at a concentration of 28% solids.

5. The concentrate of claim 1 having a solids to liquid ratio, by weight, of from between 1 to 2 to 1 to 20.

6. The concentrate of claim 1 having a clear yellow color.

7. The concentrate of claim 1 formed from silicon including trace amounts of phosphorous, iron and calcium.

8. A product comprising the concentrate of claims 1, 2, 3, 4, 6 or 7 combined with deionized water at a ratio, by weight, of approximately ½ to 2 parts concentrate to 100 parts water to form a diluted product.

9. The product of claim 8 comprising approximately 1 part concentrate to 85 to 100 parts deionized water.

10. A combination of sodium hydroxide (NaOH), silicon (Si) and deonized water (H₂O) that, after suitable processing, comprises:
a concentrate characterized by:
a pH of at least 12.65;
a sodium to silicon (Na/Si) ratio, by weight, of less than 1.0;
by NMR analysis, not a metal hydride;
a solids to liquid ratio, by weight, of between 1 to 2 to 1 to 20;
a specific gravity of between 1.23 and 1.25 at a 28% solids to liquid ratio; and
a color of amber to yellow.

11. The concentrate of claim 10 having a clear yellow color and a pH of at least 14.

12. The concentrate of claim 11 combined with approximately 85 to 100 parts by weight deionized water to form additional product.

13. A solvent comprising the diluted product of claim 12 combined with at least one of MEA, DEA and MDEA in approximately a 50/50 ratio.

14. A process for making a sodium/silicon water concentrate, comprising:
mixing approximately one unit by weight solid NaOH with two units by weight silicon in an open reaction vessel;
quickly and calmly adding approximately 8.3 units by weight room temperature distilled water over the NaOH/Si mixture;
over the next approximately 6 to 8 hours, cautiously adding small amounts of room temperature distilled water to maintain an internal temperature of the composition below approximately 300° F.;
letting the liquid set for approximately 24 hours;
separating a liquid concentrate from excess silicon by pouring concentrate off of silicon sediment in the vessel; and
sealing the concentrate from the atmospheric air for at least 100 hours.

15. A concentrate produced by the process comprising:
mixing one unit by weight solid NaOH with two units by weight silicon in an open reaction vessel;
quickly and calmly adding approximately 8.3 units by weight room temperature distilled water over the NaOH/Si mixture;
over the next approximately 6 to 8 hours, cautiously adding small amounts of room temperature distilled water to maintain an internal temperature of the liquid below approximately 300° F.;
letting the liquid set for approximately 24 hours;
separating a liquid concentrate from excess silicon by pouring concentrate off of silicon sediment in the vessel; and
sealing the concentrate from the atmospheric air for at least 100 hours.

16. The concentrate of claims 1, 10 or 15 wherein the silicon includes trace amounts of phosphorous, iron and calcium.

17. The process of claim 14 wherein the silicon includes trace amounts of phosphorous, iron and calcium.

18. A process for making a diluted product from a sodium/silicon water concentrate, comprising:
metering deionized water into a reactor vessel;
heating the water to a temperature of approximately 95° F. and holding the temperature for approximately 4 hours;
slowly injecting nitrogen gas into the upper atmosphere of the reactor vessel and opening a pressure relief valve to slowly draw out atmospheric air from the reaction medium, until a gas meter registers no CO₂ exiting;
injecting nitrogen gas until the reaction medium pressure reaches approximately 35 psi;
adding a concentrate composition in accordance with claim 1 into a bottom portion of the reactor vessel while bleeding pressure from a pressure relief valve to maintain approximately 35 psi, the ratio of concentrate to deionized water being approximately 1 part concentrate to 99 parts deionized water, by volume; and
holding the concentrate and water mixture at approximately 95° F. and 35 psi for approximately 6 hours.

19. A method of creating a solvent for gas treatment plants, comprising:
adding an amine, including at least one of MEA, DEA and MDEA, to the diluted product of claim 18 in a reactor vessel while holding temperature and pressure in the vessel at approximately 95° F. and 35 psi, the amine being added near the bottom of the reactor vessel; and
letting the mix stand for approximately 12 hours at approximately 35 psi and 95° F.
